(19) United States
(12) Patent Application Publication
(10) Pub. No.: US 2026/0116759 A1
(43) Pub. Date: Apr. 30, 2026

(54) Porous Graphene-Sulfur Balls as a Cathode Active Material for an Alkali Metal-Sulfur Battery

(71) Applicant: Honeycomb Battery Company, Dayton, OH (US)

(72) Inventors: Aruna Zhamu, Springboro, OH (US); Song-Hai Chai, Dayton, OH (US); Bor Z. Jang, Centerville, OH (US)

(73) Assignee: Honeycomb Battery Company, Dayton, OH (US)

(21) Appl. No.: 18/928,007

(22) Filed: Oct. 26, 2024

(51) Int. Cl. C01B 32/194; H01M 4/02; H01M 4/40

(52) U.S. Cl. CPC C01B 32/194; H01M 4/405; C01B 2204/22; C01B 2204/32; C01P 2002/08; C01P 2002/78; C01P 2004/32; C01P 2004/61; C01P 2004/62; C01P 2006/10; C01P 2006/12; H01M 2004/027; H01M 2004/028

(57) ABSTRACT

Powder comprising multiple porous graphene balls as a cathode active material for an alkali metal-sulfur battery, wherein a graphene balls has a diameter from 100 nm to 20 μm and comprises (i) pores and pore walls therein and (ii) sulfur or metal polysulfide residing in the pores or supported by the pore walls, and wherein (a) the pore walls comprise a plurality of graphene sheets or planes, each having a wall thickness from 0.34 nm to 100 nm, wherein preferably a plurality of graphene sheets or planes are bonded by or integral with a disordered carbon phase; and (b) the sulfur or metal polysulfide is in a form of particles or coating having a diameter or thickness from 0.5 nm to 10 μm, in physical contact with the graphene sheets or planes, and in an amount of 0.1% to 95% of the total particulate weight.

### FIELD

The present invention relates generally to the field of alkali metal-sulfur battery or alkali metal-ion sulfur battery and, more particularly, to an alkali metal-sulfur cathode having multiple graphene balls and a process for producing the graphene balls, the cathode and the battery.

### BACKGROUND

Rechargeable lithium-ion (Li-ion) and lithium metal batteries (including Li-sulfur and Li metal-air batteries) are considered promising power sources for electric vehicle (EV), hybrid electric vehicle (HEV), and portable electronic devices, such as lap-top computers and mobile phones. Lithium as a metal element has the highest capacity (3,861 mAh/g) compared to any other metal or metal-intercalated compound as an anode active material (except Li_{4.4}Si, which has a specific capacity of 4,200 mAh/g). Hence, in general, Li metal batteries have a significantly higher energy density than lithium ion batteries.

Historically, rechargeable lithium metal batteries were produced using non-lithiated compounds having relatively high specific capacities, such as TiS₂, MoS₂, MnO₂, CoO₂, and V₂O₅, as the cathode active materials, which were coupled with a lithium metal anode. When the battery was discharged, lithium ions were transferred from the lithium metal anode through the electrolyte to the cathode, and the cathode became lithiated. Unfortunately, upon repeated charges/discharges, the lithium metal resulted in the formation of dendrites at the anode that ultimately grew to penetrate through the separator, causing internal shorting and explosion. As a result of a series of accidents associated with this problem, the production of these types of secondary batteries was stopped in the early 1990's, giving ways to lithium-ion batteries.

In lithium-ion batteries, pure lithium metal sheet or film was replaced by carbonaceous materials as the anode. The carbonaceous material absorbs lithium (through intercalation of lithium ions or atoms between graphene planes, for instance) and desorbs lithium ions during the re-charge and discharge phases, respectively, of the lithium ion battery operation. The carbonaceous material may comprise primarily graphite that can be intercalated with lithium and the resulting graphite intercalation compound may be expressed as LiₓC₆, where x is typically less than 1.

Although lithium-ion (Li-ion) batteries are promising energy storage devices for electric drive vehicles, state-of-the-art Li-ion batteries have yet to meet the cost and performance targets. Li-ion cells typically use a lithium transition-metal oxide or phosphate as a positive electrode (cathode) that de/re-intercalates Li⁺ at a high potential with respect to the carbon negative electrode (anode). The specific capacity of lithium transition-metal oxide or phosphate based cathode active material is typically in the range of 140-170 mAh/g. As a result, the specific energy of commercially available Li-ion cells is typically in the range of 120-220 Wh/kg, most typically 150-180 Wh/kg. These specific energy values are two to three times lower than what would be required for battery-powered electric vehicles to be widely accepted.

With the rapid development of hybrid (HEV), plug-in hybrid electric vehicles (HEV), and all-battery electric vehicles (EV), there is an urgent need for anode and cathode materials that provide a rechargeable battery with a significantly higher specific energy, higher energy density, higher rate capability, long cycle life, and safety. One of the most promising energy storage devices is the lithium-sulfur (Li—S) cell since the theoretical capacity of Li is 3,861 mAh/g and that of S is 1,675 mAh/g. In its simplest form, a Li—S cell includes elemental sulfur as the positive electrode and lithium as the negative electrode. The lithium-sulfur cell operates with a redox couple, described by the reaction S₈+16Li↔8Li₂S that lies near 2.2 V with respect to Li⁺/Li^{o}. This electrochemical potential is approximately ⅔ of that exhibited by conventional positive electrodes (e.g. LiMnO₄). However, this shortcoming is offset by the very high theoretical capacities of both Li and S. Thus, compared with conventional intercalation-based Li-ion batteries, Li—S cells have the opportunity to provide a significantly higher energy density (a product of capacity and voltage). Assuming complete reaction to Li₂S, energy densities values can approach 2,500 Wh/kg and 2,800 Wh/l, respectively, based on the combined Li and S weight or volume. If based on the total cell weight or volume, the energy densities can reach approximately 1,000 Wh/kg and 1,100 Wh/l, respectively. However, the current Li-sulfur cells reported by industry leaders in sulfur cathode technology have a maximum cell specific energy of 250-400 Wh/kg (based on the total cell weight), which is far below what is possible.

In summary, despite its considerable advantages, the Li—S cell is plagued with several major technical problems that have thus far hindered its widespread commercialization:
(1) Conventional lithium metal cells still have dendrite formation and related internal shorting issues.
(2) Sulfur or sulfur-containing compounds are highly insulating, both electrically and ionically. To enable a reversible electrochemical reaction at high current densities or charge/discharge rates, the sulfur should maintain intimate contact with an electrically conductive additive.

Various carbon-sulfur composites have been utilized for this purpose, but only with limited success owing to the limited scale of the contact area. Typical reported capacities are between 300 and 550 mAh/g (based on the cathode carbon-sulfur composite weight) at moderate rates.
(3) The cell tends to exhibit significant capacity decay during discharge charge cycling. This is mainly due to the high solubility of the lithium polysulfide anions formed as reaction intermediates during both discharge and charge processes in the polar organic solvents used in electrolytes. During cycling, the lithium polysulfide anions can migrate through the separator to the Li negative electrode whereupon they are reduced to solid precipitates (Li₂S₂ and/or Li₂S) and remain resided in the anode side, causing active mass loss. In addition, the solid product that precipitates on the surface of the positive electrode during discharge becomes electrochemically irreversible, which also contributes to active mass loss.
(4) More generally speaking, a significant drawback with cells containing cathodes comprising elemental sulfur, organosulfur and carbon-sulfur materials relates to the dissolution and excessive out-diffusion of soluble sulfides, polysulfides, organo-sulfides, carbon-sulfides and/or carbon-polysulfides (hereinafter referred to as anionic reduction products) from the cathode into the rest of the cell. This phenomenon is commonly referred to as the Shuttle Effect. This process leads to several problems: high self-discharge rates, loss of cathode capacity, corrosion of current collectors and electrical leads leading to loss of electrical contact to active cell components, fouling of the anode surface giving rise to malfunction of the anode, and clogging of the pores in the cell membrane separator which leads to loss of ion transport and large increases in internal resistance in the cell.

In response to these challenges, new electrolytes, protective films for the lithium anode, and solid electrolytes have been developed. Some interesting cathode developments have been reported recently to contain lithium polysulfides; but, their performance still fall short of what is required for practical applications.

For instance, Ji, et al reported that cathodes based on nanostructured sulfur/meso-porous carbon materials could overcome these challenges to a large degree, and exhibit stable, high, reversible capacities with good rate properties and cycling efficiency [Xiulei Ji, Kyu Tae Lee, & Linda F. Nazar, “A highly ordered nanostructured carbon-sulphur cathode for lithium-sulphur batteries,” Nature Materials 8, 500-506 (2009)]. However, the fabrication of the proposed highly ordered meso-porous carbon structure requires a tedious and expensive template-assisted process. It is also challenging to load a large proportion of sulfur into these meso-scaled pores using a physical vapor deposition or solution precipitation process.

Zhang, et al. (US Pub. No. 2014/0234702; 08/21/2014) makes use of a chemical reaction method of depositing S particles on surfaces of isolated graphene oxide (GO) sheets. But, this method is incapable of creating a large proportion of ultra-small S particles on GO surfaces (i.e. typically <66% of S in the GO-S nanocomposite composition). The resulting Li—S cells also exhibit poor rate capability; e.g. the specific capacity of 1,100 mAh/g (based on S weight) at 0.02 C rate is reduced to <450 mAh/g at 1.0 C rate. It may be noted that the highest achievable specific capacity of 1,100 mAh/g represents a sulfur utilization efficiency of only 1,100/1,675=65.7% even at such a low charge/discharge rate (0.02 C means completing the charge or discharge process in 1/0.02=50 hours; 1 C=1 hour, 2 C=½ hours, and 3 C=⅓ hours, etc.) Further, such a S-GO nanocomposite cathode-based Li—S cell exhibits very poor cycle life, with the capacity typically dropping to less than 60% of its original capacity in less than 40 charge/discharge cycles. Such a short cycle life makes this Li—S cell not useful for any practical application. Another chemical reaction method of depositing S particles on graphene oxide surfaces is disclosed by Wang, et al. (US Pub. No. 2013/0171339; Jul. 4, 2013). This Li—S cell still suffers from the same problems.

A solution precipitation method was disclosed by Liu, et al. (US Pub. No. 2012/0088154; Apr. 12, 2012) to prepare graphene-sulfur nanocomposites (having sulfur particles adsorbed on GO surfaces) for use as the cathode material in a Li—S cell. The method entails mixing GO sheets and S in a solvent (CS₂) to form a suspension. The solvent is then evaporated to yield a solid nanocomposite, which is then ground to yield nanocomposite powder having primary sulfur particles with an average diameter less than approximately 50 nm. Unfortunately, this method does not appear to be capable of producing S particles less than 40 nm. The resulting Li—S cell exhibits very poor cycle life (a 50% decay in capacity after only 50 cycles). Even when these nanocomposite particles are encapsulated in a polymer, the Li—S cell retains less than 80% of its original capacity after 100 cycles. The cell also exhibits a poor rate capability (specific capacity of 1,050 mAh/g(S wt.) at 0.1 C rate, dropped to <580 mAh/g at 1.0 C rate). Again, this implies that a large proportion of S did not contribute to the lithium storage, resulting in a low S utilization efficiency.

Furthermore, all of the aforementioned methods involve depositing S particles onto surfaces of isolated graphene sheets. The presence of S particles (one of the most insulating materials) adhered to graphene surfaces would make the resulting electrode structure non-conducting when multiple S-bonded graphene sheets are packed together. These S particles prevent graphene sheets from contacting each other, making it impossible for otherwise conducting graphene sheets to form a 3-D network of electron-conducting paths in the cathode. This unintended and unexpected outcome is another reason why these prior art Li—S cells have performed so poorly.

Despite the various approaches proposed for the fabrication of high energy density Li—S cells, there remains a need for cathode materials, production processes, and cell operation methods that retard the out-diffusion of S or lithium polysulfide from the cathode compartments into other components in these cells, improve the utilization of electro-active cathode materials (S utilization efficiency), and provide rechargeable Li—S cells with high capacities over a large number of cycles.

Most significantly, lithium metal (including pure lithium, lithium alloys of high lithium content with other metal elements, or lithium-containing compounds with a high lithium content; e.g. >80% or preferably >90% by weight Li) still provides the highest anode specific capacity as compared to essentially all other anode active materials (except pure silicon, but silicon has pulverization issues). Lithium metal would be an ideal anode material in a lithium-sulfur secondary battery if dendrite related issues could be addressed.

Sodium metal (Na) and potassium metal (K) have similar chemical characteristics to Li and the sulfur cathode in room temperature sodium-sulfur cells (RT Na—S batteries) or potassium-sulfur cells (K—S) face the same issues observed in Li—S batteries, such as: (i) low active material utilization rate, (ii) poor cycle life, and (iii) low Coulombic efficiency. Again, these drawbacks arise mainly from insulating nature of S, dissolution of S and Na or K polysulfide intermediates in liquid electrolytes (and related Shuttle effect), and large volume change during charge/discharge.

Hence, an object of the present invention is to provide a rechargeable alkali metal battery (e. g Li—S, Na—S, and K—S battery) that exhibits an exceptionally high specific energy or high energy density. One particular technical goal of the present invention is to provide an alkali metal-sulfur or alkali ion-sulfur cell with a cell specific energy greater than 400 Wh/Kg, preferably greater than 500 Wh/Kg, and more preferably greater than 600 Wh/Kg (all based on the total cell weight).

Another object of the present invention is to provide an alkali metal-sulfur cell that exhibits a high cathode specific capacity (higher than 1,200 mAh/g based on the sulfur weight, or higher than 1,000 mAh/g based on the cathode composite weight, including sulfur, conducting additive or substrate, and binder weights combined, but excluding the weight of cathode current collector). The specific capacity is preferably higher than 1,400 mAh/g based on the sulfur weight alone or higher than 1,200 mAh/g based on the cathode composite weight. This should be accompanied by a high specific energy, good resistance to dendrite formation, and a long and stable cycle life.

It may be noted that in most of the open literature reports (scientific papers) and patent documents, scientists or inventors choose to express the cathode specific capacity based on the sulfur or lithium polysulfide weight alone (not the total cathode composite weight), but unfortunately a large proportion of non-active materials (those not capable of storing lithium, such as conductive additive and binder) is typically used in their Li—S cells. For practical use purposes, it is more meaningful to use the cathode composite weight-based capacity value.

A specific object of the present disclosure is to provide a rechargeable alkali metal-sulfur cell based on rational materials and battery designs that overcome or significantly reduce the following issues commonly associated with conventional Li—S cells: (a) extremely low electric and ionic conductivities of sulfur, requiring large proportion (typically 30-55%) of non-active conductive fillers and having significant proportion of non-accessible or non-reachable sulfur or alkali metal polysulfides); (b) dissolution of S and alkali metal polysulfide in electrolyte; (c) migration of polysulfides from the cathode to the anode (which irreversibly react with lithium, Na or K at the anode), resulting in active material loss and capacity decay (the shuttle effect); and (d) short cycle life.

### SUMMARY

The present disclosure provides powder mass, comprising multiple porous graphene balls that contain (i) pores and graphene sheet-containing pore walls and (ii) sulfur and/or metal sulfide inside these balls. The powder mass is intended for use as a cathode active material in an alkali metal-sulfur battery (e.g., lithium-sulfur or sodium-sulfur metal battery) and a process for producing such powder mass. The disclosure also provides a lithium-sulfur battery and a sodium-sulfur battery comprising such porous graphene balls as a cathode active material.

In certain embodiments, the disclosure provides a powder mass comprising multiple porous graphene balls or particulates as a cathode active material for a lithium-sulfur battery or sodium-sulfur battery, wherein at least one or all of the graphene balls or particulates has a diameter from 100 nm to 20 μm (preferably from 500 nm to 10 μm) and comprises (i) pores and pore walls therein and (ii) sulfur or metal polysulfide residing in the pores or supported by the pore walls, and wherein (a) the pore walls comprise a plurality of graphene sheets or planes, each having a length or width from 5 nm to 100 μm and a wall thickness from 0.34 nm (single graphene plane) to 100 nm (multiple graphene planes or graphene sheets stacked together), wherein preferably a plurality of graphene sheets or planes are bonded by or integral with a disordered or amorphous carbon phase and (b) the sulfur or metal polysulfide is in a form of particles or coating having a diameter or thickness from 0.5 nm to 10 μm, in physical contact with the graphene sheets or planes, and in an amount of 0.1% to 95% of the total graphene ball/articulate weight. The wall thickness is preferably from 0.34 nm to 10 nm and more preferably smaller than 3.4 nm (10 graphene planes or less stacked together).

In certain embodiments, the graphene sheets in the pore walls contain single-layer or few-layer graphene, wherein the few-layer graphene sheets have 2-10 layers of stacked graphene planes having an inter-plane spacing d₀₀₂ from 0.3354 nm to 2.0 nm as measured by X-ray diffraction and the single-layer or few-layer graphene sheets contain a pristine graphene material having essentially zero % of non-carbon elements, or a non-pristine graphene material having 0.001% to 25% by weight of non-carbon elements. The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

In certain embodiments, the graphene ball meets one or more of the following conditions: (i) the graphene ball further comprises 0.01% to 40% by weight of a binder or matrix material that holds the multiple graphene sheets or planes together to form a composite graphene ball of structural integrity; (ii) at least 2 graphene sheets or planes are bonded by or integral with a disordered or amorphous carbon phase; (iii) the graphene ball is encapsulated or coated with a coating material that is electron-conducting, ion-conducting, or both electron-and ion-conducting; (iv) the graphene ball comprises particles of a spacer to prevent graphene sheet re-stacking and regulate the pore volume; and (v) sulfur or metal polysulfide is in a form of nano-scaled particle or coating having a diameter or thickness less than 100 nm (preferably small than 50 nm, further preferably smaller than 30 nm, and most preferably small than 10 nm (but preferably no less than 3 nm).

Preferably, the binder, matrix, or coating material comprises an electron-conducting, lithium ion-conducting, or sodium ion-conducting material. The electron-conducting material may be selected from an intrinsically conducting polymer, a pitch, an amorphous carbon, a metal, or a combination thereof. The intrinsically conducting polymer is preferably selected from polyacetylene, polythiophene, poly(3-alkylthiophenes), polypyrrole, polyaniline, polyfuran, a bi-cyclic polymer, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

In the porous graphene balls, the lithium ion-conducting material (i) may be selected from a material comprising Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4; (ii) may contains a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato) borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

The lithium ion- or sodium ion-conducting material preferably comprises a lithium ion-conducting or sodium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof.

The metal polysulfide residing in the graphene balls may be selected from Li₂S₁, Li₂S₂, Li₂S₃, Li₂S₄, Li₂S₅, Li₂S₆, Li₂S₇, Li₂S₈, Li₂S₉, Li₂S₁₀, Na₂S₁, Na₂S₂, Na₂S₃, Na₂S₄, Na₂S₅, Na₂S₆, Na₂S₇, Na₂S₈, Na₂S₉, Na₂S₁₀, K₂S₁, K2S₂, K₂S₃, K₂S₄, K₂S₅, K₂S₆, K₂S₇, K₂S₈, K₂S₉, K₂S₁₀, or a combination thereof.

The graphene balls further contain an electron-conducting material dispersed in the pores and selected from an expanded graphite flake, carbon nanotube, carbon nanofiber, carbon fiber, carbon particle, graphite particle, carbon black, acetylene black, pitch, an electron-conducting polymer, or a combination thereof.

The graphene ball or particulate in the powder mass, when measured without sulfur or metal polysulfide, preferably has a density from 0.005 to 1.7 g/cm³ and a specific surface area from 50 to 2,630 m²/g. In certain embodiments, the graphene particulate, when measured without sulfur and metal sulfide, has a density from 0.1 to 1.7 g/cm³ and has some pores with an average pore size from 10 nm to 10 μm. The pores are preferably interconnected. In some embodiments, the particulate has a physical density higher than 0.8 g/cm³ and a specific surface area greater than 600 m²/g. In some embodiments, the graphene particulate has a physical density higher than 1.0 g/cm³ and a specific surface area greater than 300 m²/g.

The stacked graphene planes may have an inter-plane spacing d_{0.02} from 0.335 nm to 0.6 nm as measured by X-ray diffraction.

The graphene ball or particulate may comprise particles of a catalyst residing in said pores or deposited on said pore walls, wherein said catalyst promotes electrochemical reactions from sulfur or a first metal polysulfide to a second metal polysulfide. The catalyst preferably comprises a metal element selected from Au, Ag, Pt, Pd, Mg, Zn, Ti, K, Al, Fe, Mn, Co, Ni, Sn, V, Cr, Sc, Cu, Y, Zr, Nb, Mo, Tc, Ru, Rh, Cd, Hf, Ta, W, Re, Os, Ir, Hg, an alloy thereof, or a combination thereof. The catalyst is preferably in a metal cluster form having a diameter or width less than 10 nm, preferably less than 5 nm, further preferably less than 1 nm, and most preferably comprises a single-atom catalyst.

The present disclosure also provides an alkali metal-sulfur battery cathode containing the powder mass the disclose powder mass as a cathode active material. Also disclosed is an alkali metal-sulfur battery that comprises an anode, the herein disclosed cathode, and an electrolyte in ionic contact with both the cathode and the anode. The anode may comprise (A) a foil, particles, or filaments of lithium metal or lithium alloy, having no less than 80% by weight of lithium element in said lithium alloy, or (B) sodium metal or sodium alloy having no less than 80% by weight of sodium element in said sodium alloy.

In some embodiments, the lithium ion-conducting material in the graphene ball comprises a sulfonated polymer, which is typically conductive to lithium ions or sodium ions.

The alkali metal-sulfur battery may be a lithium metal-sulfur battery, lithium ion-sulfur batter, sodium metal-sulfur battery, or sodium ion-sulfur battery.

In a lithium-ion sulfur battery or sodium-ion sulfur battery, the presently disclosed graphene balls are used an a cathode active material and the anode can comprise an anode active material selected from the group consisting of: (A) silicon (Si), phosphorus (P), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (B) alloys or intermetallic compounds of Si, Ge, Sn, Pb, Sb, Bi, Zn, Al, Ti, Ni, Co, or Cd with other elements; (C) oxides, carbides, nitrides, sulfides, phosphides, selenides, and tellurides of Si, Ge, Sn, Pb, Sb, Bi, Zn, Al, Ti, Fe, Ni, Co, or Cd, and their mixtures, composites, or lithium-containing composites; (D) salts and hydroxides of Sn; (E) lithium titanate, lithium manganate, lithium aluminate, lithium-containing titanium oxide, lithium transition metal oxide; (F) graphite or carbon particles, filaments, fibers, nano-fibers, nano-tubes, or nano-wires; (g) pre-lithiated or pre-sodiated versions thereof, and combinations thereof.

The disclosure also provides a process for producing the invented powder mass, the process comprising: A) mixing or dispersing multiple graphene sheets, optional spacer particles, optional metal polysulfide, and a binder or matrix precursor in a liquid medium to form a dispersion or slurry; B) forming and drying the dispersion or slurry into porous solid composite balls or particulates wherein a composite ball or particulate comprises graphene sheets, optional spacer particles, pores, and a binder or matrix precursor that physically contacts, embeds, or bonds together multiple graphene sheets and spacer particles, if present; C) chemically or thermally converting the precursor into a binder or matrix (e.g., via polymerizing, cross-linking, curing, solidifying, or carbonizing the precursor) that physically contacts, embeds, or bonds together multiple graphene sheets and spacer particles, if present, to form porous graphene balls or particulates; and D) impregnating or infiltrating sulfur, metal polysulfide, or both into pores of the porous graphene balls to form the powder mass.

Step B) of forming and drying preferably comprises a procedure of spray drying, spray cooling, pan-coating, air-suspension or fluidized bed coating, centrifugal extrusion, co-extrusion, vibration nozzle coating, coacervation, freeze-drying, supercritical fluid coating, emulsification, or polymerization.

In certain embodiments, Step C) of converting the precursor into a binder or matrix comprises a procedure of polymerizing, cross-linking, curing, solidifying, or carbonizing the precursor and the precursor comprises a monomer, an oligomer, a polymer, a crosslinking agent, a pitch, petroleum or coal tar, heavy oil, polynuclear hydrocarbon, or a combination thereof.

The spacer particles may comprise particles (flakes, discs, platelets, fibers, tubes, rods, spheres, particulars of any regular or irregular shapes, etc.) of a carbon, graphite, expanded graphite, coke, meso-phase carbon, soft carbon, hard carbon, carbon black, acetylene black, carbon nano-tube, carbon nano-fiber, graphite nano-fiber, quantum dot, or a combination thereof and wherein the particles have a diameter or thickness from 5 nm to 10 μm. The spacer particles act to reduce the tendency for graphene sheets to re-stack with one another and help maintain a higher volume fraction of porosity in the graphene balls.

The procedure D) of impregnating or infiltrating preferably comprises a procedure selected from melt dipping, solution deposition, chemical vapor deposition, physical vapor deposition, sputtering, electrochemical deposition, spray coating, plasma coating, or a combination thereof.

The process may further comprise a step E) of depositing a catalyst in the pores of the porous graphene balls or particulates before, during or after step D). This step E) may comprise a procedure selected from melt dipping, solution deposition, solution-based chemical deposition, chemical vapor deposition, physical vapor deposition, sputtering, electrochemical deposition, spray coating, plasma coating, or a combination thereof.

The solution-based chemical deposition may comprise (a) depositing a catalytic metal-containing precursor into pores of the porous graphene balls and (b) heat treating the graphene balls to thermally convert or chemically treating the graphene balls to chemically reduce the metal precursor to a metal, wherein the metal resides in the pores of the resulting particulates or adheres to graphene pore walls in the particulates, wherein the metal comprises a metal element selected from Au, Ag, Pt, Pd, Mg, Zn, Ti, K, Al, Fe, Mn, Co, Ni, Sn, V, Cr, Sc, Cu, Y, Zr, Nb, Mo, Tc, Ru, Rh, Cd, Hf, Ta, W, Re, Os, Ir, Hg, an alloy thereof, or a combination thereof.

For instance, graphene wall surfaces may be coated with HAuCl₄, which is then thermally converted to Au when the graphene balls are heated. Another example is to deposit zinc chloride on graphene wall surfaces or in the pores (e.g. via salt solution dipping and drying) and use hydrogen and methane to chemically convert this precursor to Zn metal at a later stage (e.g. before or after graphene deposition). There are many metal precursors to metals that are well-known in the art.

In some embodiments, the process may include (a) depositing a metal-containing precursor (e.g. an organo-metallic molecule or a metal salt, such as a nickel acetate) onto the surfaces of graphene sheets or pore walls to form precursor-coated graphene sheets; (b) heat treating the graphene balls to thermally convert or chemically treat the graphene balls to chemically reduce the metal precursor (e.g., nickel acetate) to a metal phase (Ni nano cluster), wherein the metal resides in the pores of the resulting particulates or adheres to graphene sheet surfaces in the particulates.

The process may further comprise a procedure of encapsulating the graphene balls, after step (D), with a coating material that is electron-conducting, ion-conducting, or both electron-and ion-conducting. The coating material may comprise a material selected from an intrinsically conducting polymer, a lithium-ion conducting polymer, a sodium ion-conducting polymer, a pitch, an amorphous carbon, or a combination thereof.

The present disclosure further provides a process for producing the disclosed powder mass, the process comprising: (A) producing porous graphene balls, having pores and pore walls therein, by activating, carbonizing, and partially graphitizing a carbonaceous feedstock selected from biochar, bio-pitch, petroleum pitch, coal tar pitch, petroleum coke, coal-derived coke, carbonized pitch, meso-phase pitch, meso-carbon micro-beads (MCMB), needle coke, soft carbon, hard carbon, activated carbon, carbon fibers, or a combination thereof, wherein partial graphitization refers to a product exhibiting a degree of graphitization, g, less than 100% but greater than 0%, wherein g=(3.440−d₀₀₂)/(3.440−3.354), where 3.440 is inter-planar spacing in a partially graphitized carbon or a carbon with a turbostratic structure; d₀₀₂, with a unit Angstrom (1 Å=0.1 nm), is the value of interlayer spacing of a partially graphitized product obtained by X-ray diffraction, wherein the carbonaceous feedstock is in a particle form having a size smaller than 1 mm, preferably smaller than 100 μm, before or after the activating, carbonizing, and partially graphitizing procedure; and (B) impregnating or infiltrating sulfur, metal polysulfide, or both into pores of said porous graphene balls to form said powder mass.

The “degree of graphitization” refers to a measure of how closely a carbon material resembles the ideal crystalline structure of graphite, essentially indicating the extent to which a carbon material has transformed into a well-ordered graphite structure, usually quantified by analyzing the interplanar spacing between graphene layers using X-ray diffraction (XRD) and comparing it to the spacing in perfect graphite; a higher degree of graphitization means the material is more similar to ideal graphite with a higher level of structural order.

The degree of graphitization is primarily determined using XRD analysis, where the “d₀₀₂” spacing (distance between graphene layers) is measured and compared to the ideal graphite value to calculate a graphitization degree. In a commonly used method, the graphitization degree can be calculated by the following formula: g=(3.440−d₀₀₂)/(3.440−3.354), wherein g is the graphitization degree of a graphitic product, such as a partially graphitized carbon; 3,440 is inter-planar spacing in a partially graphitized carbon or a carbon with a turbostratic structure; d₀₀₂ is the value of interlayer spacing of graphite obtained by XRD.

A higher degree of graphitization indicates a more ordered, crystalline graphite-like structure, while a lower degree suggests a more disordered, amorphous carbon structure. The degree of graphitization is influenced by the heat treatment temperature and time during the graphitization process, with higher temperatures and longer periods of time leading to a higher degree of graphitization.

In some embodiments, Step (A) of producing graphene balls comprises a procedure selected from (i) carbonization of a feedstock followed by activation and partial graphitization; (ii) concurrent carbonization and activation of the feedstock followed by partial graphitization; or (iii) carbonization and partial graphitization followed by activation, wherein the degree of graphitization prior to activation is from 5% to 90%, preferably from 10% to 70%.

The process may further comprise a step of impregnating a catalyst into pores of porous graphene balls.

In some preferred embodiments, the process further comprises a step of encapsulating the graphene balls, after step (B), with a coating material that is electron-conducting, ion-conducting, or both electron-and ion-conducting. The encapsulating step may comprise a procedure selected from spray drying, spray cooling, pan-coating, air-suspension coating, fluidized-bed coating, freeze-drying, centrifugal extrusion, vibration nozzle coating, hydrothermal encapsulation, supercritical fluid coating, or in-situ polymerization.

The process may further comprise a step of incorporating the powder mass in a cathode (positive electrode) for a lithium-sulfur battery and then combining a cathode, a separator, and an anode to form a battery.

### BRIEF DESCRIPTION OF THE DRAWINGS

FIG. 1 A flow chart showing the most commonly used prior art process for producing highly oxidized graphene sheets that entails chemical oxidation/intercalation, rinsing, and high-temperature exfoliation procedures.

FIG. 2(A) A flow chart showing a presently invented process for producing graphene balls having sulfur and metal polysulfide residing in pores or supported on pore wall graphene sheet surfaces according to some embodiments of the present disclosure.

FIG. 2(B) Another flow chart showing a presently invented process for producing graphene balls directly from a carbonaceous feedstock material wherein the graphene pores have sulfur and metal polysulfide residing in the pores or supported on pore wall graphene sheet surfaces according to some embodiments of the present disclosure.

FIG. 3(A) Schematic of a graphene ball according to some embodiments of the present disclosure; the graphene ball or particulate containing sulfur and metal polysulfide residing in pores or supported on pore wall graphene sheet surfaces according to some embodiments of the present disclosure;

FIG. 3(B) Schematic of a graphene ball according to some embodiments of the present disclosure; the graphene ball or particulate containing sulfur and metal polysulfide residing in pores or supported on pore wall graphene sheet surfaces according to some embodiments of the present disclosure.

FIG. 4(A) Schematic of a prior art lithium metal-sulfur battery cell, typically featuring a mixture of sulfur and a large proportion of a conductive material such as carbon black.

FIG. 4(B) Schematic of a lithium metal or sodium metal battery cell according to some embodiments of the present disclosure, wherein the cathode comprises a layer of graphene balls 252 and a layer of Li or Na film 250 (foil or coating, as a Li or Na ion source) is the anode layer.

### DETAILED DESCRIPTION

For convenience, the following discussion of preferred embodiments is primarily based on Li—S cells, but the same or similar composition, structure, and methods are applicable to Na—S and K—S cells. Examples are presented for Li—S cells and room-temperature Na—S cells.

The specific capacity and specific energy of a Li—S cell (or Na—S, or K—S cell) are dictated by the actual amount of sulfur that can be implemented in the cathode active layer (relative to other non-active ingredients, such as the binder resin and conductive filler) and the utilization rate of this sulfur amount (i.e. the utilization efficiency of the cathode active material or the actual proportion of S that actively participates in storing and releasing lithium ions). Using Li—S cell as an illustrative example, a high-capacity and high-energy Li—S cell requires a high amount of S in the cathode active layer (i.e. relative to the amounts of non-active materials, such as the binder resin, conductive additive, and other modifying or supporting materials) and a high S utilization efficiency). The present invention provides such a cathode active layer, its constituent powder mass product, the resulting Li—S cell, and a method of producing such a cathode active layer and battery.

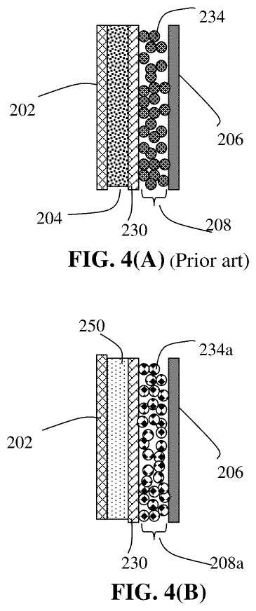

As schematically illustrated in FIG. 4(A), a prior art lithium metal-sulfur cell is typically composed of an anode current collector 202 (e.g. Cu foil 8-12 μm thick), an anode active material layer 204 (e.g. a foil of lithium metal or lithium-rich metal alloy or a layer comprising Si, Ge, P, etc.), an ion-permeable membrane or porous separator 230, a cathode active material layer 208 (containing a cathode active material, such as sulfur and metal polysulfide particles 234, and conductive additives that are all bonded by a resin binder, not shown), a cathode current collector 206 (e.g. Al foil), and an electrolyte in ionic contact with both the anode active material layer 204 (also simply referred to as the “anode layer”) and the cathode active material layer 208 (or simply “cathode layer”). The entire cell is encased in a protective housing, such as a thin plastic-aluminum foil laminate-based envelop. A prior art sodium metal cell is similarly configured, but the anode active material layer is a foil of sodium metal or sodium-rich metal, or particles of sodium.

The prior art lithium-sulfur or sodium metal-sulfur cell is typically made by a process that includes the following steps: (a) The first step is mixing and dispersing particles of the cathode active material (e.g. sulfur mixed with particles of a conductive filler, such as carbon black or acetylene black), a resin binder (e.g. PVDF) in a solvent (e.g. NMP) to form a cathode slurry; (b) The second step includes coating the cathode slurry on the surface(s) of an Al foil and drying the slurry to form a dried cathode electrode coated on the Al foil; (c) The third step includes laminating a Cu foil (as an anode current collector), a sheet of Li or Na foil (or lithium alloy or sodium alloy foil), a porous or ion-permeable separator layer, and a cathode electrode-coated Al foil sheet together to form a 5-layer assembly, which is cut and slit into desired sizes and stacked to form a rectangular structure (as an example of shape) or rolled into a cylindrical cell structure; (d) The rectangular or cylindrical laminated structure is then encased in an aluminum-plastic laminated envelope or steel casing; and (e) A liquid electrolyte is then injected into the laminated structure to make a lithium battery cell.

Due to the high specific capacity of lithium metal and sodium metal, the highest battery energy density can be achieved by alkali metal rechargeable batteries that utilize a lithium metal or sodium metal as the anode active material, provided that a solution to the safety problem can be formulated. In the Li—S cell, elemental sulfur(S) as a cathode material exhibits a high theoretical Li storage capacity of 1,672 mAh/g. With a Li metal anode, the Li—S battery has a theoretical energy density of ˜1,600 Wh/kg (per total weight of active materials). Despite its great potential, the practical realization of the Li—S battery has been hindered by several obstacles, such as low utilization of active material (necessity to add an excessive amount of conductive additive which is a non-active material and non-uniform distribution of conductive additive, making certain amount of sulfur un-accessible), high internal resistance, self-discharge, and rapid capacity fading on cycling. These technical barriers are due to the poor electrical conductivity of elemental sulfur, the high solubility of lithium polysulfides in organic electrolyte, the formation of inactivated Li₂S, the formation of Li dendrites on the anode, and high solid-electrolyte interfacial impedance at the anode. Further, the conventional sulfur cathode compositions are not amenable to the fabrication of thick cathode electrodes and, hence, not capable of incorporating a high amount of sulfur active material per centimeter squared (cm²) of the cathode layer (typically <5 mg/cm² of sulfur and often <3 mg/cm²). A sulfur loading higher than 6 mg/cm² is required in order to achieve a desirably high energy density.

We have overcome most of the aforementioned issues by developing graphene ball-based cathode material for an alkali metal-sulfur cell that exhibits a high energy, high power density, and stable cycling behavior.

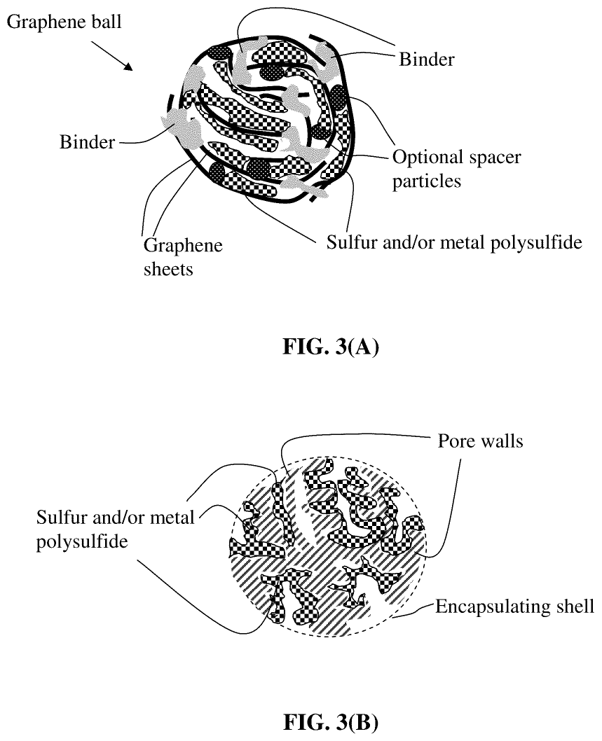

In certain embodiments, the disclosure provides a powder mass comprising multiple sulfur-containing graphene balls or particulates as a cathode active material for an alkali metal-sulfur battery (lithium-sulfur, sodium-sulfur, or potassium-sulfur battery), the graphene ball or particulate (as schematically illustrated in FIGS. 3(A) and 3(B)) has a diameter from 100 nm to 20 μm and comprises (i) pores and pore walls therein and (ii) sulfur or metal polysulfide residing in the pores or supported by the pore walls, and wherein (a) the pore walls comprise a plurality of graphene sheets or planes, each having a length or width from 5 nm to 100 μm and a wall thickness from 0.34 nm (single graphene plane) to 100 nm (multiple graphene planes or graphene sheets stacked together), wherein preferably a plurality of graphene sheets or planes are bonded by or integral with a disordered or amorphous carbon phase and (b) the sulfur or metal polysulfide is in a form of particles or coating having a diameter or thickness from 0.5 nm to 10 μm, in physical contact with the graphene sheets or planes, and in an amount of 0.1% to 95% of the total graphene ball/articulate weight. The wall thickness is preferably from 0.34 nm to 10 nm and more preferably smaller than 3.4 nm (10 graphene planes or less stacked together).

The terms “graphene particulates” and “graphene balls” are herein used interchangeably.

Schematically shown in FIG. 4(B) is a lithium-sulfur or sodium-sulfur battery cell according to some embodiments of the present disclosure, wherein the cathode comprises a layer 208a of multiple sulfur-containing graphene balls 234a supported by a cathode current collector 206 and a layer of Li or Na film 250 (or a layer of anode active material comprising graphite, carbon, Si, P, Ge, etc.) supported by an anode current collector 20 (e.g., Cu foil or porous Ni foam). This layer of Li or Na film preferably is totally ionized during the first discharge of the battery. The anode and the cathode is separated by a separator or ion-permeable membrane layer 230. Other components of this battery cell can be similar to those of the conventional lithium or sodium battery.

In certain embodiments, the graphene sheets in the pore walls contain single-layer or few-layer graphene, wherein the few-layer graphene sheets have 2-10 layers of stacked graphene planes having an inter-plane spacing d₀₀₂ from 0.3354 nm to 2.0 nm as measured by X-ray diffraction and the single-layer or few-layer graphene sheets contain a pristine graphene material having essentially zero % of non-carbon elements, or a non-pristine graphene material having 0.001% to 25% by weight of non-carbon elements. The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

In certain embodiments, the graphene ball meets one or more of the following conditions: (i) the graphene ball further comprises 0.01% to 40% by weight of a binder or matrix material that holds the multiple graphene sheets or planes together to form a composite graphene ball of structural integrity; (ii) at least 2 graphene sheets or planes are bonded by or integral with a disordered or amorphous carbon phase; (iii) the graphene ball is encapsulated or coated with a coating material that is electron-conducting, ion-conducting, or both electron-and ion-conducting; (iv) the graphene ball comprises particles of a spacer to prevent graphene sheet re-stacking and regulate the pore volume; and (v) sulfur or metal polysulfide is in a form of nano-scaled particle or coating having a diameter or thickness less than 100 nm (preferably small than 50 nm, further preferably smaller than 30 nm, and most preferably small than 10 nm (but preferably no less than 3 nm).

Preferably, the binder, matrix, or coating material comprises an electron-conducting, lithium ion-conducting, or sodium ion-conducting material. The electron-conducting material may be selected from an intrinsically conducting polymer, a pitch, an amorphous carbon, a metal, or a combination thereof. The intrinsically conducting polymer is preferably selected from polyacetylene, polythiophene, poly(3-alkylthiophenes), polypyrrole, polyaniline, polyfuran, a bi-cyclic polymer, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

In the porous graphene balls, the lithium ion-conducting material (i) may be selected from a material comprising Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4; (ii) may contains a lithium salt selected from lithium perchlorate, LiClO4, lithium hexafluorophosphate, LiPF6, lithium borofluoride, LiBF4, lithium hexafluoroarsenide, LiAsF6, lithium trifluoro-metasulfonate, LiCF₃SO₃, bis-trifluoromethyl sulfonylimide lithium, LiN(CF₃SO₂)₂, lithium bis(oxalato) borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

These lithium salts may also be used as part of an electrolyte for a lithium-sulfur battery. The lithium ion- or sodium ion-conducting material preferably comprises a lithium ion-conducting or sodium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof.

These polymers may also be used in the electrolyte of a lithium-sulfur battery.

The metal polysulfide residing in the graphene balls may be selected from Li₂S₁, Li₂S₂, Li₂S₃, Li₂S₄, Li₂S₅, Li₂S₆, Li₂S₇, Li₂S₈, Li₂S₉, Li₂S₁₀, Na₂S₁, Na₂S₂, Na₂S₃, Na₂S₄, Na₂S₅, Na₂S₆, Na₂S₇, Na₂S₈, Na₂S₉, Na₂S₁₀, K₂S₁, K2S₂, K₂S₃, K₂S₄, K₂S₅, K₂S₆, K₂S₇, K₂S₈, K₂S₉, K₂S₁₀, or a combination thereof.

The graphene balls further contain an electron-conducting material dispersed in the pores and selected from an expanded graphite flake, carbon nanotube, carbon nanofiber, carbon fiber, carbon particle, graphite particle, carbon black, acetylene black, pitch, an electron-conducting polymer, or a combination thereof.

The graphene ball or particulate in the powder mass, when measured without sulfur or metal polysulfide, preferably has a density from 0.005 to 1.7 g/cm³ and a specific surface area from 50 to 2,630 m²/g. In certain embodiments, the graphene particulate, when measured without sulfur and metal sulfide, has a density from 0.1 to 1.7 g/cm³ and has some pores with an average pore size from 10 nm to 10 μm. The pores are preferably interconnected. In some embodiments, the particulate has a physical density higher than 0.8 g/cm³ and a specific surface area greater than 600 m²/g. In some embodiments, the graphene particulate has a physical density higher than 1.0 g/cm³ and a specific surface area greater than 300 m²/g.

The stacked graphene planes may have an inter-plane spacing d₀₀₂ from 0.335 nm to 0.6 nm as measured by X-ray diffraction. An inter-plane spacing d₀₀₂ higher than 0.34 nm can be achieved by intercalating a chemical species (e.g., Na, Li, K, F, Cl, N, B atoms, O₂ molecules, —OH group, etc.) into inter-planar spaces.

The graphene ball or particulate may comprise particles of a catalyst residing in said pores or deposited on said pore walls, wherein said catalyst promotes electrochemical reactions from sulfur or a first metal polysulfide to a second metal polysulfide. The catalyst preferably comprises a metal element selected from Au, Ag, Pt, Pd, Mg, Zn, Ti, K, Al, Fe, Mn, Co, Ni, Sn, V, Cr, Sc, Cu, Y, Zr, Nb, Mo, Tc, Ru, Rh, Cd, Hf, Ta, W, Re, Os, Ir, Hg, an alloy thereof, or a combination thereof. The catalyst is preferably in a metal cluster form having a diameter or width less than 10 nm, preferably less than 5 nm, further preferably less than 1 nm, and most preferably comprises a single-atom catalyst.

The present disclosure also provides an alkali metal-sulfur battery cathode containing the powder mass the disclose powder mass as a cathode active material. Also disclosed is an alkali metal-sulfur battery that comprises an anode, the herein disclosed cathode, and an electrolyte in ionic contact with both the cathode and the anode. The anode may comprise (A) a foil, particles, or filaments of lithium metal or lithium alloy, having no less than 80% by weight of lithium element in said lithium alloy, or (B) sodium metal or sodium alloy having no less than 80% by weight of sodium element in said sodium alloy.

In some embodiments, the lithium ion-conducting material in the graphene ball comprises a sulfonated polymer, which is typically conductive to lithium ions or sodium ions.

The alkali metal-sulfur battery may be a lithium metal-sulfur battery, lithium ion-sulfur batter, sodium metal-sulfur battery, or sodium ion-sulfur battery.

In a lithium-ion sulfur battery or sodium-ion sulfur battery, the presently disclosed graphene balls are used an a cathode active material and the anode can comprise an anode active material selected from the group consisting of: (A) silicon (Si), phosphorus (P), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (B) alloys or intermetallic compounds of Si, Ge, Sn, Pb, Sb, Bi, Zn, Al, Ti, Ni, Co, or Cd with other elements; (C) oxides, carbides, nitrides, sulfides, phosphides, selenides, and tellurides of Si, Ge, Sn, Pb, Sb, Bi, Zn, Al, Ti, Fe, Ni, Co, or Cd, and their mixtures, composites, or lithium-containing composites; (D) salts and hydroxides of Sn; (E) lithium titanate, lithium manganate, lithium aluminate, lithium-containing titanium oxide, lithium transition metal oxide; (F) graphite or carbon particles, filaments, fibers, nano-fibers, nano-tubes, or nano-wires; (g) pre-lithiated or pre-sodiated versions thereof, and combinations thereof.

Graphene is a single-atom thick layer of sp² carbon atoms arranged in a honeycomb-like lattice. Graphene can be readily prepared from graphite, activated carbon, graphite fibers, carbon black, and meso-phase carbon beads. Single-layer graphene and its slightly oxidized version (GO) can have a specific surface area (SSA) as high as 2630 m²/g. It is this high surface area that enables a large amount of sulfur to be uniformly deposited on the graphene surface, yet still allowing electrons and alkali metal ions (e.g., Li⁺ and Na⁺ ions) to only have to travel a short distance.

Carbon is known to have five unique crystalline structures, including diamond, fullerene (0-D nano graphitic material), carbon nano-tube or carbon nano-fiber (1-D nano graphitic material), graphene (2-D nano graphitic material), and graphite (3-D graphitic material). The carbon nano-tube (CNT) refers to a tubular structure grown with a single wall or multi-wall. Carbon nano-tubes (CNTs) and carbon nano-fibers (CNFs) have a diameter on the order of a few nanometers to a few hundred nanometers. Their longitudinal, hollow structures impart unique mechanical, electrical and chemical properties to the material. The CNT or CNF is a one-dimensional nano carbon or 1-D nano graphite material.

A single-layer graphene sheet is composed of carbon atoms occupying a two-dimensional hexagonal lattice. Multi-layer graphene is a platelet composed of more than one graphene plane. Individual single-layer graphene sheets and multi-layer graphene platelets are herein collectively called nano graphene platelets (NGPs) or graphene materials. NGPs include pristine graphene (essentially 99% of carbon atoms), slightly oxidized graphene (<5% by weight of oxygen), graphene oxide (≥5% by weight of oxygen), slightly fluorinated graphene (<5% by weight of fluorine), graphene fluoride ((≥5% by weight of fluorine), other halogenated graphene, and chemically functionalized graphene.

Our research group pioneered the development of graphene materials and related production processes as early as 2002: (1) B. Z. Jang and W. C. Huang, “Nano-scaled Graphene Plates,” U.S. Pat. No. 7,071,258 (Jul. 4, 2006), application submitted on Oct. 21, 2002; (2) B. Z. Jang, et al. “Process for Producing Nano-scaled Graphene Plates,” U.S. patent application Ser. No. 10/858,814 (Jun. 3, 2004); and (3) B. Z. Jang, A. Zhamu, and J. Guo, “Process for Producing Nano-scaled Platelets and Nanocomposites,” U.S. patent application Ser. No. 11/509,424 (Aug. 25, 2006). Our research group also presented the first review article on various processes for producing NGPs and NGP nanocomposites [Bor Z. Jang and A Zhamu, “Processing of Nano Graphene Platelets (NGPs) and NGP Nanocomposites: A Review,” J. Materials Sci. 43 (2008) 5092-5101]. Four main prior-art approaches have been followed to produce NGPs. The most commonly used process is chemical oxidation and reduction of graphite to produce graphene oxide (GO) and reduced graphene oxide (RGO).

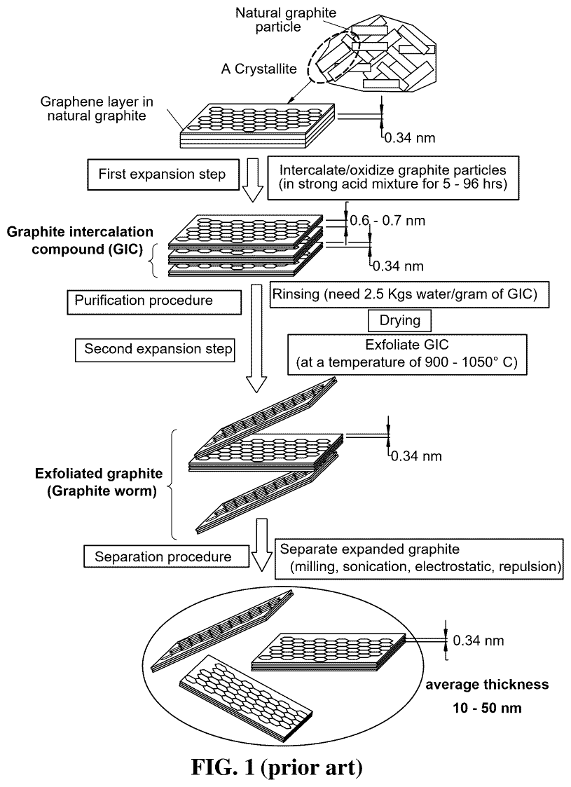

This process, as schematically illustrated in FIG. 1, entails treating natural graphite powder with an intercalant and an oxidant (e.g., concentrated sulfuric acid and nitric acid, respectively) to obtain a graphite intercalation compound (GIC) or, actually, graphite oxide (GO). [William S. Hummers, Jr., et al., Preparation of Graphitic Oxide, Journal of the American Chemical Society, 1958, p. 1339.] Prior to intercalation or oxidation, graphite has an inter-graphene plane spacing of approximately 0.335 nm (L_{d}=½d₀₀₂=0.335 nm). With an intercalation and oxidation treatment, the inter-graphene spacing is increased to a value typically greater than 0.6 nm. This is the first expansion stage experienced by the graphite material during this chemical route. The obtained GIC or GO is then subjected to further expansion (often referred to as exfoliation) using either a thermal shock exposure or a solution-based, ultrasonication-assisted graphene layer exfoliation approach.

In the thermal shock exposure approach, the GIC or GO is exposed to a high temperature (typically 800-1,050° C.) for a short period of time (typically 15 to 60 seconds) to exfoliate or expand the GIC or GO for the formation of exfoliated or further expanded graphite, which is typically in the form of a “graphite worm” composed of graphite flakes that are still interconnected with one another. This thermal shock procedure can produce some separated graphite flakes or graphene sheets, but normally the majority of graphite flakes remain interconnected. Typically, the exfoliated graphite or graphite worm is then subjected to a flake separation treatment using air milling, mechanical shearing, or ultrasonication in water. Hence, approach 1 basically entails three distinct procedures: first expansion (oxidation or intercalation), further expansion (or “exfoliation”), and separation.

In the solution-based separation approach, the expanded but un-exfoliated or exfoliated GO powder is dispersed in water or aqueous alcohol solution, which is subjected to ultrasonication. It is important to note that in these processes, ultrasonification is used after intercalation and oxidation of graphite (i.e., after first expansion) and can be after thermal shock exposure of the resulting GIC or GO (after second expansion). Alternatively, the GO powder dispersed in water is subjected to an ion exchange or lengthy purification procedure in such a manner that the repulsive forces between ions residing in the inter-planar spaces overcome the inter-graphene van der Waals forces, resulting in graphene layer separations.

In the aforementioned examples, the starting material for the preparation of graphene sheets or NGPs is a graphitic material that may be selected from the group consisting of natural graphite, artificial graphite, graphite oxide, graphite fluoride, graphite fiber, carbon fiber, carbon nano-fiber, carbon nano-tube, mesophase carbon micro-bead (MCMB) or carbonaceous micro-sphere (CMS), soft carbon, hard carbon, and combinations thereof.

Graphite oxide may be prepared by dispersing or immersing a laminar graphite material (e.g., powder of natural flake graphite or synthetic graphite) in an oxidizing agent, typically a mixture of an intercalant (e.g., concentrated sulfuric acid) and an oxidant (e.g., nitric acid, hydrogen peroxide, sodium perchlorate, potassium permanganate) at a desired temperature (typically 0-70° C.) for a sufficient length of time (typically 4 hours to 5 days). The resulting graphite oxide particles are then rinsed with water several times to adjust the pH values to typically 2-5. The resulting suspension of graphite oxide particles dispersed in water is then subjected to ultrasonication to produce a dispersion of separate graphene oxide sheets dispersed in water. A small amount of reducing agent (e.g. Na₄B) may be added to obtain reduced graphene oxide (RGO) sheets.

In order to reduce the time required to produce a precursor solution or suspension, one may choose to oxidize the graphite to some extent for a shorter period of time (e.g., 30 minutes-4 hours) to obtain graphite intercalation compound (GIC). The GIC particles are then exposed to a thermal shock, preferably in a temperature range of 600-1,100° C. for typically 15 to 60 seconds to obtain exfoliated graphite or graphite worms, which are optionally (but preferably) subjected to mechanical shearing (e.g. using a mechanical shearing machine or an ultrasonicator) to break up the graphite flakes that constitute a graphite worm. Either the already separated graphene sheets (after mechanical shearing) or the un-broken graphite worms or individual graphite flakes are then re-dispersed in water, acid, or organic solvent and ultrasonicated to obtain a graphene dispersion.

The pristine graphene material is preferably produced by one of the following three processes: (A) Intercalating the graphitic material with a non-oxidizing agent, followed by a thermal or chemical exfoliation treatment in a non-oxidizing environment; (B) Subjecting the graphitic material to a supercritical fluid environment for inter-graphene layer penetration and exfoliation; or (C) Dispersing the graphitic material in a powder form to an aqueous solution containing a surfactant or dispersing agent to obtain a suspension and subjecting the suspension to direct ultrasonication to obtain a graphene dispersion.

In Procedure (A), a particularly preferred step comprises (i) intercalating the graphitic material with a non-oxidizing agent, selected from an alkali metal (e.g., potassium, sodium, lithium, or cesium), alkaline earth metal, or an alloy, mixture, or eutectic of an alkali or alkaline metal; and (ii) a chemical exfoliation treatment (e.g., by immersing potassium-intercalated graphite in ethanol solution).

In Procedure (B), a preferred step comprises immersing the graphitic material to a supercritical fluid, such as carbon dioxide (e.g., at temperature T>31° C. and pressure P>7.4 MPa) and water (e.g., at T>374° C. and P>22.1 MPa), for a period of time sufficient for inter-graphene layer penetration (tentative intercalation). This step is then followed by a sudden de-pressurization to exfoliate individual graphene layers. Other suitable supercritical fluids include methane, ethane, ethylene, hydrogen peroxide, ozone, water oxidation (water containing a high concentration of dissolved oxygen), or a mixture thereof.

In Procedure (C), a preferred step comprises (a) dispersing particles of a graphitic material in a liquid medium containing therein a surfactant or dispersing agent to obtain a suspension or slurry; and (b) exposing the suspension or slurry to ultrasonic waves (a process commonly referred to as ultrasonication) at an energy level for a sufficient length of time to produce a graphene dispersion of separated graphene sheets (non-oxidized NGPs) dispersed in a liquid medium (e.g. water, alcohol, or organic solvent).

Graphene materials can be produced with an oxygen content no greater than 25% by weight, preferably below 20% by weight, further preferably below 5%. Typically, the oxygen content is between 5% and 20% by weight. The oxygen content can be determined using chemical elemental analysis and/or X-ray photoelectron spectroscopy (XPS). When the oxygen content of graphene oxide exceeds 30% by weight (more typically when >35%), the GO molecules dispersed or dissolved in water for a GO gel state.

The laminar graphite materials used in the prior art processes for the production of the GIC, graphite oxide, and subsequently made exfoliated graphite, flexible graphite sheets, and graphene platelets were, in most cases, natural graphite. However, the present invention is not limited to natural graphite. The starting material may be selected from the group consisting of natural graphite, artificial graphite (e.g., highly oriented pyrolytic graphite, HOPG), graphite oxide, graphite fluoride, graphite fiber, carbon fiber, carbon nano-fiber, carbon nano-tube, mesophase carbon micro-bead (MCMB) or carbonaceous micro-sphere (CMS), soft carbon, hard carbon, and combinations thereof. All of these materials contain graphite crystallites that are composed of layers of graphene planes stacked or bonded together via van der Waals forces. In natural graphite, multiple stacks of graphene planes, with the graphene plane orientation varying from stack to stack, are clustered together. In carbon fibers, the graphene planes are usually oriented along a preferred direction. Generally speaking, soft carbons are carbonaceous materials obtained from carbonization of liquid-state, aromatic molecules. Their aromatic ring or graphene structures are more or less parallel to one another, enabling further graphitization. Hard carbons are carbonaceous materials obtained from aromatic solid materials (e.g., polymers, such as phenolic resin and polyfurfuryl alcohol). Their graphene structures are relatively randomly oriented and, hence, further graphitization is difficult to achieve even at a temperature higher than 2,500° C. But, graphene sheets do exist in these carbons.

Fluorinated graphene or graphene fluoride is herein used as an example of the halogenated graphene material group. There are two different approaches that have been followed to produce fluorinated graphene: (1) fluorination of pre-synthesized graphene: This approach entails treating graphene prepared by mechanical exfoliation or by CVD growth with fluorinating agent such as XeF₂, or F-based plasmas; (2) Exfoliation of multilayered graphite fluorides: Both mechanical exfoliation and liquid phase exfoliation of graphite fluoride can be readily accomplished [F. Karlicky, et al. “Halogenated Graphenes: Rapidly Growing Family of Graphene Derivatives” ACS Nano, 2013, 7 (8), pp 6434-6464].

Interaction of F₂ with graphite at high temperature leads to covalent graphite fluorides (CF)ₙ or (C₂F)ₙ, while at low temperatures graphite intercalation compounds (GIC) CₓF (2≤x ≤24) form. In (CF)ₙ carbon atoms are sp³-hybridized and thus the fluorocarbon layers are corrugated including trans-linked cyclohexane chains. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents may be used, although most of the available literature involves fluorination with F₂ gas, sometimes in presence of fluorides.

For exfoliating a layered precursor material to the state of individual single graphene layers or few-layers, it is necessary to overcome the attractive forces between adjacent layers and to further stabilize the layers. This may be achieved by either covalent modification of the graphene surface by functional groups or by non-covalent modification using specific solvents, surfactants, polymers, or donor-acceptor aromatic molecules. The process of liquid phase exfoliation includes ultra-sonic treatment of a graphite fluoride in a liquid medium to produce graphene fluoride sheets dispersed in the liquid medium. The resulting dispersion can be directly used in the graphene deposition of polymer component surfaces.

The nitrogenation of graphene can be conducted by exposing a graphene material, such as graphene oxide, to ammonia at high temperatures (200-400° C.). Nitrogenated graphene could also be formed at lower temperatures by a hydrothermal method; e.g. by sealing GO and ammonia in an autoclave and then increased the temperature to 150-250° C. Other methods to synthesize nitrogen doped graphene include nitrogen plasma treatment on graphene, arc-discharge between graphite electrodes in the presence of ammonia, ammonolysis of graphene oxide under CVD conditions, and hydrothermal treatment of graphene oxide and urea at different temperatures.

For the purpose of defining the claims of the instant application, NGPs or graphene materials include discrete sheets/platelets of single-layer and multi-layer (typically less than 10 layers, the few-layer graphene) pristine graphene, graphene oxide, reduced graphene oxide (RGO), graphene fluoride, graphene chloride, graphene bromide, graphene iodide, hydrogenated graphene, nitrogenated graphene, chemically functionalized graphene, doped graphene (e.g. doped by B or N). Pristine graphene has essentially 0% oxygen. RGO typically has an oxygen content of 0.001%-5% by weight. Graphene oxide (including RGO) can have 0.001%-50% by weight of oxygen. Other than pristine graphene, all the graphene materials have 0.001%-50% by weight of non-carbon elements (e.g. O, H, N, B, F, Cl, Br, I, etc.). These materials are herein referred to as non-pristine graphene materials. The presently invented graphene can contain pristine or non-pristine graphene and the invented method allows for this flexibility. These graphene sheets all can be chemically functionalized.

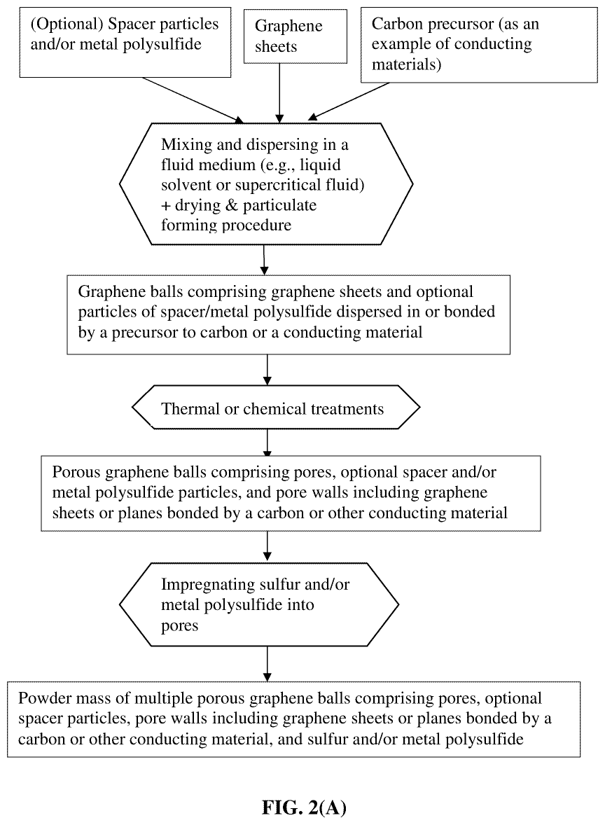

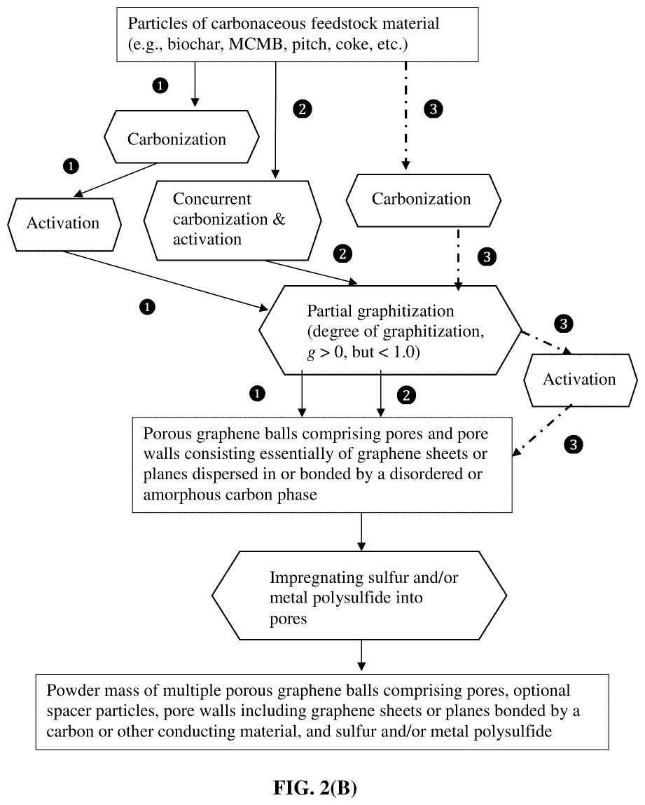

The powder mass of graphene balls or particulates for an alkali metal-sulfur battery may be produced by two processes as respectively illustrated in FIGS. 2(A) and (B).

The disclosure provides a process for producing the invented powder mass, the process (FIG. 2(A)) comprising: A) mixing or dispersing multiple graphene sheets, optional spacer particles, optional metal polysulfide, and a binder or matrix precursor in a liquid medium to form a dispersion or slurry; B) forming and drying the dispersion or slurry into porous solid composite balls or particulates wherein a composite ball or particulate comprises graphene sheets, optional spacer particles, pores, and a binder or matrix precursor that physically contacts, embeds, or bonds together multiple graphene sheets and spacer particles, if present; C) chemically or thermally converting the precursor into a binder or matrix (e.g., via polymerizing, cross-linking, curing, solidifying, or carbonizing the precursor) that physically contacts, embeds, or bonds together multiple graphene sheets and spacer particles, if present, to form porous graphene balls or particulates; and D) impregnating or infiltrating sulfur, metal polysulfide, or both into pores of the porous graphene balls to form the powder mass.

Step B) of forming and drying preferably comprises a procedure of spray drying, spray cooling, pan-coating, air-suspension or fluidized bed coating, centrifugal extrusion, co-extrusion, vibration nozzle coating, coacervation, freeze-drying, supercritical fluid coating, emulsification, or polymerization.

The gaps between the free ends of the graphene sheets in porous graphene balls may be advantageously bonded by an intrinsically conducting polymer, amorphous carbon, a pitch, a metal, etc. Due to these unique chemical composition (including oxygen or fluorine content, etc.), morphology, crystal structure (including inter-graphene spacing), and structural features (e.g. degree of orientations, few defects, chemical bonding and no gap between graphene sheets, and substantially no interruptions along graphene plane directions), the graphene particulates have a unique combination of outstanding thermal conductivity, electrical conductivity, mechanical strength, and elasticity.

In certain embodiments, Step C) of converting the precursor into a binder or matrix comprises a procedure of polymerizing, cross-linking, curing, solidifying, or carbonizing the precursor and the precursor comprises a monomer, an oligomer, a polymer, a crosslinking agent, a pitch, petroleum or coal tar, heavy oil, polynuclear hydrocarbon, or a combination thereof.

The spacer particles may comprise particles (flakes, discs, platelets, fibers, tubes, rods, spheres, particulars of any regular or irregular shapes, etc.) of a carbon, graphite, expanded graphite, coke, meso-phase carbon, soft carbon, hard carbon, carbon black, acetylene black, carbon nano-tube, carbon nano-fiber, graphite nano-fiber, quantum dot, or a combination thereof and wherein the particles have a diameter or thickness from 5 nm to 10 μm. The spacer particles act to reduce the tendency for graphene sheets to re-stack with one another and help maintain a higher volume fraction of porosity in the graphene balls.

The procedure D) of impregnating or infiltrating preferably comprises a procedure selected from melt dipping, solution deposition, chemical vapor deposition, physical vapor deposition, sputtering, electrochemical deposition, spray coating, plasma coating, or a combination thereof.

The process may further comprise a step E) of depositing a catalyst in the pores of the porous graphene balls or particulates before, during or after step D). This step E) may comprise a procedure selected from melt dipping, solution deposition, solution-based chemical deposition, chemical vapor deposition, physical vapor deposition, sputtering, electrochemical deposition, spray coating, plasma coating, or a combination thereof.

The solution-based chemical deposition may comprise (a) depositing a catalytic metal-containing precursor into pores of the porous graphene balls and (b) heat treating the graphene balls to thermally convert or chemically treating the graphene balls to chemically reduce the metal precursor to a metal, wherein the metal resides in the pores of the resulting particulates or adheres to graphene pore walls in the particulates, wherein the metal comprises a metal element selected from Au, Ag, Pt, Pd, Mg, Zn, Ti, K, Al, Fe, Mn, Co, Ni, Sn, V, Cr, Sc, Cu, Y, Zr, Nb, Mo, Tc, Ru, Rh, Cd, Hf, Ta, W, Re, Os, Ir, Hg, an alloy thereof, or a combination thereof.

For instance, graphene wall surfaces may be coated with HAuCl₄, which is then thermally converted to Au when the graphene balls are heated. Another example is to deposit zinc chloride on graphene wall surfaces or in the pores (e.g. via salt solution dipping and drying) and use hydrogen and methane to chemically convert this precursor to Zn metal at a later stage (e.g. before or after graphene deposition). There are many metal precursors to metals that are well-known in the art.

In some embodiments, the process may include (a) depositing a metal-containing precursor (e.g. an organo-metallic molecule or a metal salt, such as a nickel acetate) onto the surfaces of graphene sheets or pore walls to form precursor-coated graphene sheets; (b) heat treating the graphene balls to thermally convert or chemically treat the graphene balls to chemically reduce the metal precursor (e.g., nickel acetate) to a metal phase (Ni nano cluster), wherein the metal resides in the pores of the resulting particulates or adheres to graphene sheet surfaces in the particulates.

The process may further comprise a procedure of encapsulating the graphene balls, after step (D), with a coating material that is electron-conducting, ion-conducting, or both electron- and ion-conducting. The coating material may comprise a material selected from an intrinsically conducting polymer, a lithium-ion conducting polymer, a sodium ion-conducting polymer, a pitch, an amorphous carbon, or a combination thereof.

The present disclosure further provides a process (FIG. 2(B)) for producing the disclosed powder mass, the process comprising: (A) producing porous graphene balls, having pores and pore walls therein, by activating, carbonizing, and partially graphitizing a carbonaceous feedstock selected from biochar, bio-pitch, petroleum pitch, coal tar pitch, petroleum coke, coal-derived coke, carbonized pitch, meso-phase pitch, meso-carbon micro-beads (MCMB), needle coke, soft carbon, hard carbon, activated carbon, carbon fibers, or a combination thereof, wherein partial graphitization refers to a product (i) exhibiting a degree of graphitization, g, less than 100% but greater than 0%, wherein g=(3.440−d₀₀₂)/(3.440−3.354), where 3.440 is a reference inter-planar spacing in a graphite material with a turbostratic structure; d₀₀₂, with a unit Angstrom (1 Å=0.1 nm), is the value of interlayer spacing of a partially graphitized product obtained by X-ray diffraction and door is no greater than 3.440 Å, or (ii) having a interlayer spacing in the range 3.440<d₀₀₂<20 Å, wherein the carbonaceous feedstock is in a particle form having a size smaller than 1 mm, preferably smaller than 100 μm, before or after the activating, carbonizing, and partially graphitizing procedure; and (B) impregnating or infiltrating sulfur, metal polysulfide, or both into pores of said porous graphene balls to form said powder mass.

The “degree of graphitization” refers to a measure of how closely a carbon material resembles the ideal crystalline structure of graphite, essentially indicating the extent to which a carbon material has transformed into a well-ordered graphite structure, usually quantified by analyzing the interplanar spacing between graphene layers using X-ray diffraction (XRD) and comparing it to the spacing in perfect graphite; a higher degree of graphitization means the material is more similar to ideal graphite with a higher level of structural order,

The degree of graphitization is primarily determined using XRD analysis, where the “d₀₀₂” spacing (distance between graphene layers) is measured and compared to the ideal graphite value to calculate a graphitization degree. In a commonly used method, the graphitization degree can be calculated by the following formula: g=(3.440−d₀₀₂)/(3.440−3.354), wherein g is the graphitization degree of a graphitic product, such as a partially graphitized carbon; 3.440 is inter-planar spacing in a partially graphitized carbon or a carbon with a turbostratic structure; d₀₀₂ is the value of interlayer spacing of graphite obtained by XRD.

A higher degree of graphitization indicates a more ordered, crystalline graphite-like structure, while a lower degree suggests a more disordered, amorphous carbon structure. The degree of graphitization is influenced by the heat treatment temperature and time during the graphitization process, with higher temperatures and longer periods of time leading to a higher degree of graphitization.

In some embodiments, Step (A) of producing graphene balls comprises a procedure selected from (i) carbonization of a feedstock followed by activation and partial graphitization (Route 1 in FIG. 2(B)); (ii) concurrent carbonization and activation of the feedstock followed by partial graphitization (Route 2 in FIG. 2(B)); or (iii) carbonization and partial graphitization followed by activation (Route 3 in FIG. 2(B)), wherein the degree of graphitization prior to activation is from 5% to 90%, preferably from 10% to 70%. Partial graphitization tends to increase the structural integrity, pore sizes, thermal conductivity and electrical conductivity; these features are essential to the success of graphene balls serving as a stable and reliable host for sulfur and metal polysulfide.

The process may further comprise a step of impregnating a catalyst into pores of porous graphene balls.

In some preferred embodiments, the process further comprises a step of encapsulating the graphene balls, after step (B), with a coating material that is electron-conducting, ion-conducting, or both electron-and ion-conducting. The encapsulating step may comprise a procedure selected from spray drying, spray cooling, pan-coating, air-suspension coating, fluidized-bed coating, freeze-drying, centrifugal extrusion, vibration nozzle coating, hydrothermal encapsulation, supercritical fluid coating, or in-situ polymerization.

The process may further comprise a step of incorporating the powder mass in a cathode (positive electrode) for a lithium-sulfur battery and then combining a cathode, a separator, and an anode to form a battery.

There are three broad categories of methods that can be implemented to form graphene balls or particulates as produced according to FIG. 2(A), for instance. These include physical methods, physico-chemical methods, and chemical methods. The physical methods include pan-coating, air-suspension coating, centrifugal extrusion, vibration nozzle coating, and spray-drying methods. The physico-chemical methods include ionotropic gelation and coacervation-phase separation methods. The chemical methods include interfacial polycondensation, interfacial cross-linking, in-situ polymerization, and matrix polymerization. Several preferred processes are briefly discussed below:

Pan-coating method: The pan coating process involves tumbling a mixture of graphene sheets, particles of a Li or Na ion-attracting metal, an optional adhesive, and an optional conductive additive in a pan or a similar device while the encapsulating material (e.g. graphene sheets dispersed in a monomer/oligomer, polymer melt, polymer/solvent solution) is applied slowly until a desired encapsulating shell thickness is attained.

Air-suspension coating method: In the air suspension coating process, a mixture of graphene sheets, particles of a Li or Na ion-attracting metal, an optional adhesive, and an optional conductive additive is dispersed into the supporting air stream in an encapsulating chamber. A controlled stream of a suspension comprising graphene sheets dispersed in a polymer-solvent solution (e.g. polymer or its monomer or oligomer dissolved in a solvent; or its monomer or oligomer alone in a liquid state) is concurrently introduced into this chamber, allowing the solution to hit and coat the suspended mixture particles. These suspended particles are coated with polymer/graphene sheets while the volatile solvent is removed, producing balls of polymer-bonded graphene sheets along with the metal particles supported thereon.

Vibrational nozzle encapsulation method: Graphene balls containing graphene sheets and metal particles (or metal-coated graphene sheets) can be conducted using a laminar flow through a nozzle and vibration of the nozzle or the liquid. The vibration has to be done in resonance with the Rayleigh instability, leading to very uniform droplets. The liquid can include any liquids with limited viscosities (1-50,000 mPa·s): emulsions, suspensions or slurry containing the metal particles and graphene sheets dispersed in a liquid medium.

Spray-drying: Spray drying may be used to combine graphene sheets and metal particles (or metal-decorated graphene sheets) into graphene balls from a suspension comprising multiple graphene sheets and metal particles (or metal-decorated graphene sheets) suspended in a liquid medium or a polymer solution. In spray drying, the liquid feed (solution or suspension) is atomized to form droplets which, upon contacts with hot gas, allow solvent to get vaporized and graphene sheets and metal particles (or metal-coated graphene sheet) naturally self-assemble into graphene balls.

The process may further comprise a step of combining a plurality of presently disclosed porous graphene-sulfur particulates together to form a cathode electrode. The process may then further comprise a step of combining such a cathode, an anode (negative electrode), and an electrolyte in ionic contact with both the cathode and the anode electrode to form an alkali metal-sulfur battery cell.

The aforementioned features and characteristics make the graphene-sulfur hybrid particulates an ideal battery cathode active material in an alkali metal-sulfur battery for the following reasons.
1) Graphene sheets bridged with a conducting material (with electrical conductivity orders of magnitude higher than that of carbon black) provide a network of electron-conducting pathways without interruption, allowing for low resistance to electron transport and enabling the option of reducing or eliminating the addition of an electron conductivity additive in the anode.
2) The exceptional thermal conductivity of graphene sheets/planes in a graphene ball enables fast heat dissipation in a lithium-sulfur cell, significantly reducing the tendency of a lithium-sulfur or sodium-sulfur to suffer from thermal run-away danger.
3) The high specific surface area and the 2D nature of graphene sheets are intrinsically compatible with S molecules (also a 2D planar structure) enable deposition of a good and controllable amount of sulfur on graphene surfaces. This important feature makes it possible to provide a high S loading in the cathode, enabling a high energy density.
4) The notion that sulfur and lithium polysulfide are enclosed in a graphene/carbon- or graphene/polymer-based conducting shell, makes it easy for such secondary particles to be made into very thick cathode active layer, an essential feature to achieving a high specific energy of an alkali metal-sulfur cell.
5) The encapsulating shell also acts to confine various lithium polysulfide species during the required conversion reactions during battery charging and discharging operations, effectively eliminating the shuttling effect that otherwise causes a short cycle life.

Electrolyte is an important ingredient in a battery. A wide range of electrolytes can be used for practicing the instant invention. Most preferred are non-aqueous liquid, polymer gel, solid polymer, in organic solid-state electrolytes, and composite/hybrid solid electrolytes although other types can be used. Polymer, polymer gel, and solid-state electrolytes are preferred over liquid electrolyte.

The non-aqueous electrolyte to be employed herein may be produced by dissolving an electrolytic salt in a non-aqueous solvent. Any known non-aqueous solvent which has been employed as a solvent for a lithium secondary battery can be employed. A non-aqueous solvent mainly including a mixed solvent comprising ethylene carbonate (EC) and at least one kind of non-aqueous solvent whose melting point is lower than that of aforementioned ethylene carbonate and whose donor number is 18 or less (hereinafter referred to as a second solvent) may be preferably employed. This non-aqueous solvent is advantageous in that it is (a) effective in suppressing the reductive or oxidative decomposition of electrolyte; and (b) high in conductivity. A non-aqueous electrolyte solely composed of ethylene carbonate (EC) is advantageous in that it is relatively stable against carbonaceous filament materials. However, the melting point of EC is relatively high, 39 to 40° C., and the viscosity thereof is relatively high, so that the conductivity thereof is low, thus making EC alone unsuited for use as a secondary battery electrolyte to be operated at room temperature or lower. The second solvent to be used in a mixture with EC functions to make the viscosity of the solvent mixture lower than that of EC alone, thereby promoting the ion conductivity of the mixed solvent. Furthermore, when the second solvent having a donor number of 18 or less (the donor number of ethylene carbonate is 16.4) is employed, the aforementioned ethylene carbonate can be easily and selectively solvated with lithium ion, so that the reduction reaction of the second solvent with the carbonaceous material well developed in graphitization is assumed to be suppressed. Further, when the donor number of the second solvent is controlled to not more than 18, the oxidative decomposition potential to the lithium electrode can be easily increased to 4 V or more, so that it is possible to manufacture a lithium secondary battery of high voltage.

Preferable second solvents are dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene and methyl acetate (MA). These second solvents may be employed singly or in a combination of two or more. More desirably, this second solvent should be selected from those having a donor number of 16.5 or less. The viscosity of this second solvent should preferably be 28 cps or less at 25° C.

The electrolytic salts to be incorporated into a non-aqueous electrolyte may be selected from a lithium salt such as lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃) and bis-trifluoromethyl sulfonylimide lithium [LiN(CF₃SO₂)₂]. Among them, LiPF₆, LiBF₄ and LiN(CF₃SO₂)₂ are preferred. The content of aforementioned electrolytic salts in the non-aqueous solvent is preferably from 0.5 to 3.5 mol/l.

For sodium metal batteries, the organic electrolyte may contain an alkali metal salt preferably selected from sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), bis-trifluoromethyl sulfonylimide potassium (KN(CF₃SO₂)₂), an ionic liquid salt, or a combination thereof.

The ionic liquid is composed of ions only. Ionic liquids are low melting temperature salts that are in a molten or liquid state when above a desired temperature. For instance, a salt is considered as an ionic liquid if its melting point is below 100° C. If the melting temperature is equal to or lower than room temperature (25° C.), the salt is referred to as a room temperature ionic liquid (RTIL). The IL salts are characterized by weak interactions, due to the combination of a large cation and a charge-delocalized anion. This results in a low tendency to crystallize due to flexibility (anion) and asymmetry (cation).

A typical and well-known ionic liquid is formed by the combination of a 1-ethyl-3-methylimidazolium (EMI) cation and an N, N-bis(trifluoromethane)sulphonamide (TFSI) anion. This combination gives a fluid with an ionic conductivity comparable to many organic electrolyte solutions and a low decomposition propensity and low vapor pressure up to ˜300-400° C. This implies a generally low volatility and non-flammability and, hence, a much safer electrolyte for batteries.

Ionic liquids are basically composed of organic ions that come in an essentially unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide, and hexafluorophosphate as anions. Based on their compositions, ionic liquids come in different classes that basically include aprotic, protic and zwitterionic types, each one suitable for a specific application.

Common cations of room temperature ionic liquids (RTILs) include, but not limited to, tetraalkylammonium, di-, tri-, and tetra-alkylimidazolium, alkylpyridinium, dialkyl-pyrrolidinium, dialkylpiperidinium, tetraalkylphosphonium, and trialkylsulfonium. Common anions of RTILs include, but not limited to, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3} results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte ingredient (a salt and/or a solvent) in a battery.

There is no limitation on what kinds of electrolytes that can be used to work with the presently disclosed graphene-sulfur balls. Common electrolytes for lithium-sulfur batteries include the following species: (1) Lithium bis-(trifluoromethanesulfonyl)imide (LiTFSI), which is a popular salt due to its thermal stability, compatibility with ether solvents, and high dissociation ability; (2) Lithium trifluoromethanesulfonate (LiCF₃SO₃), a popular salt due to its thermal stability, compatibility with ether solvents, and high dissociation ability; (3) Ether-based electrolytes: a common electrolyte is IM LiTFSI in a mixture of TEGDME and DOL (1:1 v/v) with LiNO₃ as an additive; (4) Fluorinated ethers: Solvents like 1,1,2,2-tetrafluoroethyl-2,2,3,3-tetrafluoropropyl ether (TTE) and 1,2-(1,1,2,2-tetrafluoroethoxy) ethane (TFEE) are gaining interest due to their electronegative F atoms. Other electrolytes for lithium-sulfur batteries include: DOL/DME, DOL/TEGDME, THF/DOL/toluene, and DME/DOL/DGM. The choice of salt can significantly impact the properties of the electrolyte and the battery. For example, LiTFSI is generally more conductive than LiTf.

The following examples are used to illustrate some specific details about the best modes of practicing the instant invention and should not be construed as limiting the scope of the invention.

### EXAMPLE 1

### Production of Porous Graphene Balls (Graphene Particulates) from Chemically Oxidized Flake Graphite

Graphite oxide was prepared by oxidation of graphite flakes with an oxidizer liquid including sulfuric acid, sodium nitrate, and potassium permanganate at a ratio of 4:1:0.05 at 30° C. When natural graphite flakes (particle sizes of 14 μm) were immersed and dispersed in the oxidizer mixture liquid for 48 hours, the suspension or slurry appears and remains optically opaque and dark. After 48 hours, the reacting mass was rinsed with water 3 times to adjust the pH value to at least 3.0. A final amount of water was then added to prepare a series of GO-water suspensions. A water soluble polymer (Polyacrylamide, PAM) was added into the prepared suspension having a PAM-to-GO ratio of 1/10. The total solute content of the suspension was approximately 5% by weight. The suspension was spray-dried into secondary particles (particulates) that contained GO and PAM with GO dispersed in and bonded by PAM. The particulates were then subjected to heat treatments at 250° C. for 1 hour, 500° C. for 2 hours, and then 750° C. for 1 hour for producing porous graphene balls containing pores and pore walls including graphene sheets bonded by amorphous carbon, the carbon phase was converted from PAM.

For incorporation of higher melting point metals (e.g. Au, Ag, Ni, Co, Mn, Fe, and Ti) as a catalyst in graphene particulates, a small but controlled amount of a precursor material (e.g. HAuCl₄, silver nitrate, or nickel acetate) was separately added into separate samples of Go-water-PAM suspension. The resulting slurries were then spray-dried into graphene particulates, wherein the graphene sheets are coated with a metal precursor. Upon heating of the graphene particulates at a desired temperature (typically 450-750° C.) for a desired length of time (typically 0.5-2.0 hours), the precursor became nano-scaled particles of metal (e.g. Au, Ag, and Ni metal) bonded on graphene sheet surfaces. With a small amount of a metal salt, the catalytic metal was typically deposited on graphene surfaces in the form of nano-clusters (1-6 nm); in some cases, single-atom catalyst.

In order to impregnate sulfur into the pores of porous graphene balls, with or without a catalyst, batches of graphene balls and a desired amount of sulfur were sealed in a pressure chamber. Sulfur infiltration was carried out by heating the container to 170° C. for 1 h, in which the sulfur vapor reached the saturation pressure inside the container and, finally, a powder mass of porous graphene-sulfur balls was fabricated in each batch. The sulfur content in the porous graphene-sulfur particulates was controlled by adjusting the reaction time and sulfur content. The sulfur loading of the obtained electrode was as high as 7-12 mg/cm².

### EXAMPLE 2

### Preparation of Single-Layer Graphene Sheets and Graphene Balls from Graphitized Meso-Carbon Micro-Beads (MCMBs)

Meso-carbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulphate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours. The GO sheets contain oxygen proportion of approximately 35%-47% by weight for oxidation treatment periods of 48-96 hours. A water soluble polymer (Poly(ethylene oxide), PEO, and N-Vinylpyrrolidone, PVP) was separately added into two GO-water suspension samples, which were then spray-dried to produce graphene balls. After a heat treatment at 250° C. for 1 hour and 700° C. for 2 hours, we obtained porous graphene balls having particle diameters in the range of 6.6-13.7 μm.

### EXAMPLE 3

### Preparation of Pristine Graphene Balls (0% Oxygen)

Recognizing the possibility of the high defect population in GO sheets acting to reduce the conductivity of individual graphene plane, we decided to study if the use of pristine graphene sheets (non-oxidized and oxygen-free, non-halogenated and halogen-free, etc.) can lead to graphene balls having a higher thermal or electrical conductivity. Pristine graphene sheets were produced by using the direct ultrasonication or liquid-phase production process.

In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are substantially no other non-carbon elements.

The graphene-water suspension was divided up into two samples. One sample was added with water-soluble PAM and then subjected to spray-drying to produce graphene balls containing graphene sheets bonded by PAM. This first sample was then heat-treated to obtain porous graphene balls containing pristine graphene sheets bonded by amorphous carbon; this is herein referred to as the first powder mass. The powder sample was then infiltrated with sulfur by following a step described in Example 1. The product from the first powder mass was already in the form of desired sulfur-containing graphene balls and was ready to be made into a cathode electrode for a lithium-sulfur or sodium-sulfur battery.

The second graphene-water suspension was then mixed with a solution of PEDOT/PSS dissolved in water. It may be noted that Poly(3,4-ethylenedioxy-thiophene): polystyrene sulfonate (PEDOT: PSS) is a polymer mixture of two ionomers. One component is made up of sodium polystyrene sulfonate, which is a sulfonated polystyrene. Part of the sulfonyl groups are deprotonated and carry a negative charge. The other component poly(3,4-ethylenedioxy-thiophene) or PEDOT is a conjugated polymer, polythiophene, which carries positive charges. Together the two charged polymers form a macromolecular salt, which is soluble in water. The mixture was then spray-dried to form porous graphene balls comprising pores and pore walls including graphene sheets bonded by an electron-conducting polymer.

### EXAMPLE 4

### Preparation of Graphene Balls from Graphene Fluoride

Several processes have been used by us to produce GF, but only one process is herein described as an example. In a typical procedure, highly exfoliated graphite (HEG) was prepared from intercalated compound C₂F·xClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, but ethanol, 1-propanol, 2-propanol, 1-butanol, tert-butanol, isoamyl alcohol all can be used) and subjected to an ultrasound treatment (280 W) for 30 min, leading to the formation of homogeneous yellowish dispersion. Polyethylene oxide (PEO) was then dissolved in an alcohol-water solution and mixed with the yellowish dispersion to form a dispersion, which was spray-dried into graphene balls. The graphene balls were then heat-treated to form porous graphene balls containing pore walls including fluorinated graphene sheets bonded by carbon.

### EXAMPLE 5

### Preparation of Graphene Balls from Nitrogenated Graphene

Graphene oxide (GO), synthesized in Example 1, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained have nitrogen contents of 14.7, 18.2 and 17.5 wt % respectively as measured by elemental analysis. These nitrogenated graphene sheets remain dispersible in water. The resulting suspensions were then added with PEDOT: PSS and then spray-dried into graphene balls that comprise pores and pore walls containing graphene sheets bonded by an intrinsically electron-conducting polymer.

### EXAMPLE 6

### Preparation Of Graphene Balls Comprising Lithium Polysulfides And Sulfur In The Pores Of The Graphene Balls Prepared in Examples 1-5

An electrochemical deposition procedure was conducted with porous graphene balls, which were confined in a metal cage to serve as a working electrode. In a typical procedure, a metal polysulfide (MₓS_{y}) was dissolved in a solvent (e.g. mixture of DOL/DME in a volume ratio from 1:3 to 3:1) to form an electrolyte solution. An amount of a lithium salt may be optionally added, but this is not required for external electrochemical deposition. A wide variety of solvents can be utilized for this purpose and there is no theoretical limit to what type of solvents can be used; any solvent can be used provided that there is some solubility of the metal polysulfide in this desired solvent. A greater solubility would mean a larger amount of sulfur can be derived from the electrolyte solution.

The electrolyte solution is then poured into a chamber or reactor under a dry and controlled atmosphere condition (e.g. He or Nitrogen gas). A metal foil can be used as the anode and a cage of the porous graphene balls as the working electrode (a cathode); both being immersed in the electrolyte solution. This configuration constitutes an electrochemical deposition system. The step of electrochemically depositing nano-scaled sulfur particles or coating on the graphene surfaces in the pores was conducted at a current density preferably in the range of 1 mA/g to 10 A/g, based on the layer weight of the porous graphene structure.

The chemical reactions that occur in this reactor may be represented by the following equation: MₓS_{y}->MₓS_{y-z}+zS (typically z=1-4). Quite surprisingly, the precipitated S is preferentially nucleated and grown on massive graphene surfaces to form nano-scaled coating or nano particles. The coating thickness or particle diameter and the amount of S coating/particles may be controlled by the specific surface area, electro-chemical reaction current density, temperature and time. In general, a lower current density and lower reaction temperature lead to a more uniform distribution of S and the reactions are easier to control. A longer reaction time leads to a larger amount of S deposited on graphene surfaces and the reaction is ceased when the sulfur source is consumed or when a desired amount of S is deposited.

### EXAMPLE 7

### Preparation of Sulfur-Loaded Graphene Balls Encapsulated by an Ion-Conducting Polymer

The graphene balls loaded with sulfur (prepared in Example 1) were encapsulated by an ion-conducting polymer, poly(vinylidene fluoride)-hexafluoropropylene (PVDF-HFP) using spray-drying and dip coating separately. First, PVDF-HFP was dissolved in acetone to form a polymer solution. In the dip-coating procedure, a sample featuring a porous metal mesh cage containing sulfur-loaded graphene balls therein was immersed in the polymer solution for 1-10 minutes and then retreated and let dry in a slightly heated vacuum chamber. The graphene balls were coated with a thin layer of PVDF-HFP with a thickness in the range of 15 nm to 36 nm.

Separately, sulfur-loaded graphene balls were dispersed in the PVDF-HFP/acetone solution to form a slurry, which was then spray-dried to form a polymer-encapsulated graphene balls. The encapsulating shells were found to be typically from 6 to 16 nm.

### EXAMPLE 8

### Preparation of Sulfur-Loaded Graphene Balls from Partially Graphitized MCMB

Green (un-graphitized) MCMB particles were used as a starting material. We used two different amounts of starting material (400 g and 100 g), Other than this difference in starting amounts, all other variables were the same in the following activation procedures. The particles were impregnated with zinc chloride (ZnCh₂) at 1:1 wt. ratio and were kept at 80° C. for 14 h.

Heat treatments were then carried out under constant nitrogen flow (5 l/h). The beat treatment temperature was raised at 4° C./min up to 600° C., which was maintained for 3 h. The samples were then washed to remove excess reagent and dried at 110° C. for about 3 h. The resulting samples were labeled as CA-600 (chemically activated at 600).

A portion of these samples was then also submitted to a partial graphitization treatment by raising the temperature 1,550° C. at a rate of 25° C./min under nitrogen flow and then stayed at 1,550° C. for two hours. These samples were then labeled as CA-1550. It was observed that combined chemical activation and partial graphitization treatments led to a higher porosity level and slightly higher pore sizes that are more readily accessible to sulfur infiltration. In addition, the electrical conductivity and thermal conductivity were significantly increased. Combined X-ray diffraction, SEM and TEM studies indicate the formation of domains of graphene planes dispersed in a substantially disordered carbon matrix. Sulfur infiltration was conducted by sealing the porous graphene balls and sulfur in a pressure chamber by following the procedure described in Example 1.

### EXAMPLE 9

### Preparation of Sulfur-Loaded Graphene Balls From Partially Graphitized Bio-Char

In chemical activation, inorganic compounds or salts, such as zinc chloride, sodium hydroxide, potassium hydroxide, or phosphoric acid, can be used to convert the biochar to activated carbon. In this study, potassium hydroxide was used as the activating agent and the desired nitrogen flow rate, potassium hydroxide-to-biochar mass ratio, and activation temperature were varied. Activation temperatures were set between 550° C. and 800° C., along with nitrogen flow rates ranging from 80 cc/min to 250 cc/min, and mass ratios from 0.25 to 3. Chemical activation was achieved by exposing biochar to the desired amount of potassium hydroxide mixed with 100 ml of water, and allowing the mixture to sit for 2 hours at room temperature. Following this, samples were dried overnight at a temperature of 120° C. Subsequently, 200 grams of the dried sample was put in a fixed-bed reactor and heated to a temperature of 300° C. at a rate of 3 ° C./min, it was then held at 300° C. for 1 hour. Following the temperature hold at 300° C., the temperature was further increased at a rate of 3° C./min until it achieved the desired activation temperature. Once the desired temperature was reached, activation took place for 2 hours. The products were washed with water, then hydrogen chloride, and then distilled water to remove unwanted compounds and salts. Finally, the sample was dried for 12 hours at a temperature of 110° C. The activated carbon products with an activation temperature lower than 800° C. were characterized with a low electric conductivity, low thermal conductivity, and low structural integrity (quite fragile). These properties are not favorable to the use of these porous carbon particles as a host for sulfur for the alkali metal-sulfur battery application.

We have observed that increases in the carbonization and/or activation temperature above 1,500° C. effectively induced the formation of larger condensed aromatic networks arranged in interconnected conducting domains, which are essentially graphene planes (typically 1-9 planes stacked together, but could be larger in number) dispersed in some disordered carbon structure, The degree of graphitization can reach approximately 45% when the partial graphitization temperature was up to 2,000° C. Again, the electrical conductivity and thermal conductivity were significantly increased. Combined X-ray diffraction, SEM and TEM studies indicate the formation of domains of graphene planes dispersed in a substantially disordered carbon matrix. Sulfur infiltration was conducted by sealing the porous graphene balls and sulfur in a pressure chamber by following the procedure described in Example 1.

1. A powder mass comprising multiple porous graphene balls or particulates as a cathode active material for an alkali metal-sulfur battery, wherein at least one or all of said graphene balls or particulates has a diameter from 100 nm to 20 μm and comprises (i) pores and pore walls therein and (ii) sulfur or metal polysulfide residing in said pores or supported by said pore walls, and wherein (a) said pore walls comprise a plurality of graphene sheets or planes, each having a length or width from 5 nm to 100 μm and a wall thickness from 0.34 nm to 100 nm, wherein preferably a plurality of graphene sheets or planes are bonded by or integral with a disordered or amorphous carbon phase; and (b) said sulfur or metal polysulfide is in a form of particles or coating having a diameter or thickness from 0.5 nm to 10 μm, in physical contact with the graphene sheets or planes, and in an amount of 0.1% to 95% of the total particulate weight.

2. The powder mass of claim 1, wherein said graphene sheets contain single-layer or few-layer graphene, wherein said few-layer graphene sheets have 2-10 layers of stacked graphene planes having an inter-plane spacing d₀₀₂ from 0.3354 nm to 2.0 nm as measured by X-ray diffraction and said single-layer or few-layer graphene sheets contain a pristine graphene material having essentially zero % of non-carbon elements, or a non-pristine graphene material having 0.001% to 25% by weight of non-carbon elements.

3. The powder mass of claim 2, wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

4. The powder mass of claim 1, wherein said graphene ball meets one or more of the following conditions: (i) the graphene ball further comprises 0.01% to 40% by weight of a binder or matrix material that holds said multiple graphene sheets or planes together to form a composite graphene ball of structural integrity; (ii) at least 2 graphene sheets or planes are bonded by or integral with a disordered or amorphous carbon phase; (iii) the graphene ball is encapsulated or coated with a coating material that is electron-conducting, ion-conducting, or both electron-and ion-conducting; (iv) the graphene ball comprises particles of a spacer to prevent graphene sheet re-stacking and regulate a pore volume; and (v) sulfur or metal polysulfide is in a form of nano-scaled particle or coating having a diameter or thickness less than 100 nm.

5. The powder mass of claim 4, wherein said binder, matrix, or coating material comprises an electron-conducting, lithium ion-conducting, or sodium ion-conducting material.

6. The porous graphene particulate of claim 5, wherein said electron-conducting material is selected from an intrinsically conducting polymer, a pitch, an amorphous carbon, a metal, or a combination thereof.

7. The powder mass of claim 6, wherein said intrinsically conducting polymer is selected from polyacetylene, polythiophene, poly(3-alkylthiophenes), polypyrrole, polyaniline, polyfuran, a bi-cyclic polymer, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

8. The powder mass of claim 5, wherein said lithium ion-conducting material is selected from a material comprising Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

9. The powder mass of claim 5, wherein said lithium ion-conducting material contains a lithium salt selected from lithium perchlorate, LiClO₄, lithium hexafluorophosphate, LiPF₆, lithium borofluoride, LiBF₄, lithium hexafluoroarsenide, LiAsF6, lithium trifluoro-metasulfonate, LiCF₃SO₃, bis-trifluoromethyl sulfonylimide lithium, LiN(CF₃SO₂)₂, lithium bis(oxalato) borate, LiBOB, lithium oxalyldifluoroborate, LiBF₂C₂O₄, lithium oxalyldifluoroborate, LiBF₂C₂O₄, lithium nitrate, LiNO3, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

10. The powder mass of claim 5, wherein said lithium ion- or sodium ion-conducting material comprises a lithium ion-conducting or sodium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof.

11. The powder mass of claim 1, wherein said metal polysulfide contains Li₂S₁, Li₂S₂, Li₂S₃, Li₂S₄, Li₂S₅, Li₂S₆, Li₂S₇, Li₂S₈, Li₂S₉, Li₂S₁₀, Na₂S₁, Na₂S₂, Na₂S₃, Na₂S₄, Na₂S₅, Na₂S₆, Na₂S₇, Na₂S₈, Na₂S₉, Na₂S₁₀, K₂S₁, K₂S₂, K₂S₃, K₂S₄, K₂S₅, K₂S₆, K₂S₇, K₂S₈, K₂S₉, K₂S₁₀, or a combination thereof.

12. The powder mass of claim 1, wherein said graphene balls further contain an electron-conducting material dispersed in said pores and selected from an expanded graphite flake, carbon nanotube, carbon nano-fiber, carbon fiber, carbon particle, graphite particle, carbon black, acetylene black, pitch, an electron-conducting polymer, or a combination thereof.

13. The powder mass of claim 1, wherein said graphene ball or particulate, when measured without said sulfur or metal polysulfide, has a density from 0.005 to 1.7 g/cm³ and a specific surface area from 50 to 2,630 m²/g.

14. The powder mass of claim 1, wherein said stacked graphene planes have an inter-plane spacing d₀₀₂ from 0.34 nm to 0.6 nm as measured by X-ray diffraction.

15. The powder mass of claim 1, wherein said graphene ball or particulate comprises particles of a catalyst residing in said pores or deposited on said pore walls, wherein said catalyst promotes electrochemical reactions from sulfur or a first metal polysulfide to a second metal polysulfide.

16. The powder mass of claim 15, wherein said catalyst comprises a metal element selected from Au, Ag, Pt, Pd, Mg, Zn, Ti, K, Al, Fe, Mn, Co, Ni, Sn, V, Cr, Sc, Cu, Y, Zr, Nb, Mo, Tc, Ru, Rh, Cd, Hf, Ta, W, Re, Os, Ir, Hg, an alloy thereof, or a combination thereof.

17. An alkali metal-sulfur battery cathode containing the powder mass of claim 1 as a cathode active material.

18. An alkali metal-sulfur battery comprising an anode, the cathode of claim 17, and an electrolyte in ionic contact with both said cathode and said anode.

19. The alkali metal battery of claim 18, wherein said anode comprises (A) a foil, particles, or filaments of lithium metal or lithium alloy, having no less than 80% by weight of lithium element in said lithium alloy, or (B) sodium metal or sodium alloy having no less than 80% by weight of sodium element in said sodium alloy.

20. A process for producing the powder mass of claim 4, the process comprising:
A) Mixing or dispersing multiple graphene sheets, spacer particles, metal polysulfide, and a binder or matrix precursor in a liquid medium to form a dispersion or slurry;
B) forming and drying said dispersion or slurry into porous solid composite balls or particulates wherein a composite ball or particulate comprises graphene sheets, spacer particles, pores, and a binder or matrix precursor that physically contacts, embeds, or bonds together multiple graphene sheets and spacer particles, if present;
C) chemically or thermally converting said precursor into a binder or matrix (e.g., via polymerizing, cross-linking, curing, solidifying, or carbonizing the precursor) that physically contacts, embeds, or bonds together multiple graphene sheets and spacer particles, if present, to form porous graphene balls or particulates; and
D) impregnating or infiltrating sulfur, metal polysulfide, or both into pores of said porous graphene balls to form said powder mass.

21.-35. (canceled)
